(19) United States
(12) Patent Application Publication
(10) Pub. No.: US 2017/0220743 A1
(43) Pub. Date: Aug. 3, 2017

(54) TRACKING REAL-TIME ASSESSMENT OF QUALITY MONITORING IN ENDOSCOPY

(71) Applicant: INDIANA UNIVERSITY RESEARCH AND TECHNOLOGY CORPORATION, Indianapolis, IN (US)

(72) Inventors: Timothy Imler, Zionsville, IN (US); Justin Gaetano Morea, Carmel, IN (US)

(73) Assignee: Indiana University Research and Technology Corporation, Indianapolis, IN (US)

(21) Appl. No.: 15/119,464

(22) PCT Filed: Sep. 11, 2014
(86) PCT No.: PCT/US14/55185

§ 371 Date: Aug. 17, 2016

Related U.S. Application Data
(60) Provisional application No. 61/941,789, filed on Feb. 19, 2014.

(51) Int. Cl. G06F 19/00; G06F 17/27; G06F 17/22

(52) U.S. Cl. CPC G06F 19/322; G06F 19/345; G06F 19/327; G06F 19/3487; G06F 17/2247; G06F 17/2735; G06Q 10/10

(57) ABSTRACT

The present disclosure provides a method for making clinical recommendations, comprising receiving pathology reports by a computing device; processing the pathology reports by the computing device using natural language processing software, including a custom pathology dictionary; generating, using the computing device, a document based on the processing of the pathology reports; and using the document to output a clinical recommendation.

### PRIORITY CLAIM

This Application claims priority to U.S. Provisional Patent Application No. 61/941,789, filed Feb. 19, 2014, the entire disclosure of which is hereby expressly incorporated by reference.

### FIELD

The present disclosure relates generally to a system that uses natural language processing software to extract and organize data to provide useful information for clinical decision support. More particularly, the present disclosure relates to a method for extracting and analyzing data from clinical full-text documents, and presenting the data to assist in clinical decision support.

### BACKGROUND

There is an increasing emphasis on procedural quality improvement in health care systems and across large health care providers. Such procedural quality improvement is needed, for example, in gastroenterology and gastrointestinal endoscopy, yet electronic medical records are currently underutilized as a vehicle for providing physicians with feedback. Several interventions have been attempted to improve reporting outcomes to individual physicians, yet the optimal approach remains unclear.

Improvement in patient outcomes is a driving factor within the healthcare industry and an increasing focus within, for example, gastroenterology. Appropriateness and technical performance of endoscopic procedures have been identified as high impact areas for decreasing complications and improving outcomes. In order to improve quality and lower costs in gastrointestinal endoscopy, there is a critical need to develop tools to improve adherence to evidence-based practices and guidelines. Conventional tools include natural language processing (“NLP”) and template driven endoscopy software, which can extract quality measurements from procedure reports in a semi-automated manner.

In 2012, screening for and surveillance of colorectal cancer (“CRC”), the third leading cause of cancer death in the U.S., was the standard of care. There are practice guidelines from several organizations supporting both CRC screening and surveillance, which are focused on ensuring appropriateness of the test selection and frequency. In addition to the guidelines, endoscopic practice is further guided by quality indicators for performance of colonoscopies. The guidelines and quality indicators exist to optimize effectiveness, minimize risk, and control costs. Although the colonoscopy procedure currently dominates both CRC screening and surveillance in the U.S., the need for guidelines and performance indicators is relevant to other screening and surveillance tests.

Screening colonoscopy's strength is to identify and remove precancerous (adenomatous) polyps. Adenoma detection rate (“ADR”), defined as the proportion of screening colonoscopies in which one or more adenoma is detected multiplied by 100, is inversely related to the risk of interval colorectal cancer (cancer diagnosed after an initial colonoscopy and before the next scheduled screening or surveillance exam), advanced-stage disease, and fatal interval cancer in a dose-dependent fashion. In a recent report, each 1% increase in ADR was associated with a 3% decrease in risk for an interval cancer. ADR's vary widely amongst endoscopists (7.4-52.5%) making it an important quality and performance metric. However, ADR cannot easily be extracted from electronic data, limiting the ability to monitor and improve colonoscopy quality.

Despite guideline recommendations, there appears to be “misuse” of colonoscopy screening. Once neoplastic tissue has been identified, a follow-up colonoscopy is recommended, a process known as surveillance. Surveillance colonoscopy is possibly over-utilized among patients who need it least and under-utilized among those who need it most. A system that could measure proper use of surveillance would enhance the effectiveness and cost-effectiveness of colonoscopy and could be utilized for a pay-for performance system.

Brenner and colleagues have linked an excessively long surveillance interval to development of interval cancer, reinforcing the importance of recommending a safe surveillance interval for the individual patient. (See Brenner H., et al., Interval cancers after negative colonoscopy: population-based case-control study. Gut 2011). On the other hand, Goodwin and colleagues have used Medicare claims data to show overuse of screening colonoscopy among older patients. (See Goodwin J. S., et al., Overuse of screening colonoscopy in the Medicare population. Archives of Internal Medicine 2011; 171:1335-43). Schoen and colleagues have reported both overuse and underuse of surveillance colonoscopy. (See Schoen R. E., et al., Utilization of surveillance colonoscopy in community practice. Gastroenterology 2010; 138:73-81).

At the same time, indicators of colonoscopy quality, most notably the ADR, vary widely among endoscopists. Having emerged as the preferred quality metric, the adenoma detection rate has been linked to the risk of interval CRC. In an analysis of more than 45,000 persons who had screening colonoscopy by 186 endoscopists, Kaminski and colleagues found that an ADR of less than 20% was associated with a greater than 10-fold increased risk of interval CRC. (See Kaminski M. F., et al., Quality indicators for colonoscopy and the risk of interval cancer. The New England Journal of Medicine 2010; 362:1795-1803.)

Currently, there are no health information tools available to reliably capture adenoma detection rates and provide feedback to endoscopists. Registry systems such as the GI Quality Improvement Consortium (“GIQuIC”) have been expanding rapidly in their role for colonoscopy quality, but have yet to develop a mechanism for accurate real-time capture. There has been significant progress using electronic health records to develop earlier interventions and warning systems in other medical specialties. Manual reporting techniques, however, are expensive and not reliable for large-scale assessment of endoscopic procedures. Having an “early warning system” for procedural quality may allow for interventions to improve care.

Electronic delivery of endoscopic reports has been a focus since the early 1990's. Increasingly, endoscopists are using procedural software tools instead of manual dictation to produce reports. These tools (e.g., Provation® MD Gastroenterology, Endosoft®, CORI Endoscopic Reporting Software, etc.) are template driven and provide the opportunity to capture many discrete data points such as indication, maneuver, and complication, which are not captured for billing and would normally require extensive manual record review.

However, template driven systems are often cumbersome. Anecdotally, endoscopists frequently use free-text entry instead of templated entries to more explicitly describe the procedure, and this free-text entry compromises the integrity of discrete data captured by software designed to extract pre-defined macros. Increasingly, endoscopists are using procedural software instead of manual dictation to produce reports. While free-texting improves the readability of an endoscopic report, it compromises the accuracy of the data extraction using procedural software; this underscores the importance of incorporating natural language processing into the data extraction process.

Natural language processing offers a means to extract quality measurements from clinician reports; for example, endoscopic retrograde cholangiopancreatography (“ERCP”) reports, to supplement template driven measurement. Despite remarkable advances in NLP for medical and non-medical purposes, its use in gastroenterology remains limited. NLP supplements deficiencies of template-driven procedural software and reduces the time and cost required for quality monitoring by eliminating the need for manual review.

One embodiment of the present disclosure, tracking real time assessment of quality monitoring in endoscopy (“TRAQME”), allows gastroenterologists to be accurately and efficiently tracked for outcomes based on previously hidden variables in free-text documents. NLP is a tool that may be utilized in such a system. NLP is a computer-based linguistics technique that uses artificial intelligence to extract information from text reports. NLP has been utilized in the medical field, but has been limited by accuracy, location, and context specific utilization. Several reports from single sites have reported accuracies of NLP quality measurements, including adenoma detection rate. These studies have been limited by their narrow linguistic variation, potentially not reflective of clinical practice where providers express the same concept or disease entity without much uniformity.

For example, ERCP is the highest risk endoscopic procedure, having an overall complication rate of 15% that includes severe acute pancreatitis and death. An estimated 600,000 ERCP's are performed in the U.S. annually, the majority by low volume providers (<50 per year) in low volume facilities that would be expected to derive the greatest benefit from a quality improvement intervention effort. Nevertheless, less attention is paid to the assessment of quality in ERCP compared to standard endoscopic procedures (e.g., colonoscopy).

The American Society for Gastrointestinal Endoscopy (“ASGE”) Workforce on Quality in Endoscopy has outlined measureable endpoints for ERCP, which include intra-procedural maneuvers such as cannulation of the intended duct and placement of a pancreatic stent. The workforce also included negative markers such as use of pre-cut sphincterotomy and entering a non-intended duct. Even though these intra-procedural maneuvers were deemed the most important, they are also the most challenging variables to measure, as they are often entered as free text within the procedure report requiring manual review to accurately identify and capture.

Currently, there are no health information tools to reliably identify and capture ERCP-specific quality metrics that can be subsequently used to provide feedback to endoscopists. Registry systems such as GIQuIC have been expanding their role for colonoscopy-specific data capture, but have yet to collect ERCP-specific data.

As indicated above, the utilization of free-texting improves the readability of an endoscopic report, but can compromise the accuracy of using procedural software to extract data. This underscores the importance of incorporating NLP into the data extraction process. An accurate system for tracking of colonoscopy quality and surveillance intervals could improve the effectiveness and cost-effectiveness of colorectal cancer screening and surveillance. NLP, for instance, offers a means to extract adenoma detection rates from colonoscopy reports. As noted, despite remarkable advancements in NLP for medical and non-medical purposes, its use in gastroenterology remains limited. Health care providers, insurers, and other parties are unable to assess compliance rates with guideline surveillance intervals.

Thus, there is a need for a system that uses NLP software in combination with clinical decision support (“CDS”) software to extract and organize data and provide useful information to interested health care parties including doctors, insurers, and patients. More particularly, there is a need for a method for extracting and analyzing data from clinical full-text documents, and presenting the data to assist clinical decision support regarding patient surveillance intervals. Discussed herein are systems and methods for extracting, analyzing, recording, and reporting data to clinicians to assist in clinical decision support, particularly in the field of gastroenterology.

### SUMMARY

The present disclosure is directed toward tracking real time assessment of quality monitoring in endoscopy (“TRAQME”). Objective feedback on quality measures to endoscopists will improve patient selection, allow the avoidance of high-risk procedures and technical maneuvers, and increase the use of evidence-based preventive techniques, thereby reducing the rate of procedure-related complications. With an increased emphasis on improving quality and lowering costs, there is a critical need to develop tools to improve adherence to evidence-based practices and guidelines in endoscopy. The innovative information technology framework TRAQME addresses this deficit.

One aim of the TRAQME framework is to provide a platform for accurate quality tracking of endoscopic procedure data and to provide this data to providers, payers, and patients. This directly seeks to improve patient outcomes by providing feedback to providers and promoting changes in behavior through quality metric monitoring and quality reporting. The TRAQME framework will also advantageously compile quality metric data by individual provider and provide this data to payer sources for potential pay-for-performance measurement and improvement in cost-effectiveness.

Within TRAQME, quality metrics can be extracted from medical procedure reports using NLP and endoscopy software that optionally contains pre-defined templates. Extracted quality metrics are then used to assist in CDS, which uses two or more items of patient data to generate case-specific recommendations.

In one embodiment, NLP can track procedures in patient health records and provide adenoma detection rates and surveillance guideline intervals that can be used for quality tracking to improve patient outcomes. Templated endoscopy software can complement NLP for further confirmation of quality tracking.

In another embodiment, during a pre-processing stage, the open-source clinical Text Analysis and Knowledge Extraction System (“cTakes”) is used to review free text colonoscopy and/or ERCP reports having an indication of choledocholithiasis (taken from the ERCP outcomes cohort). Retrospective pilot data measuring the accuracy of NLP (compared to manual physician review) is generated for extracting selected ERCP quality measures. The quality measures optionally include: (1) informed consent documentation; (2) ASGE grading of difficulty; (3) operator assessment of difficulty; (4) whether intended duct is canulated; (5) whether pre-cut sphincterotomy is used; (6) complete extraction of bile duct stones; and (7) largest size of stone. Other quality features may optionally be used.

In other embodiments, cTakes can be used to extract select quality metrics derived from the ASGE Taskforce Guidelines, for example, from consecutive ERCP's performed for choledocholithiasis. The data can be stored within patient care networks or otherwise large regional health information exchanges.

In one embodiment, inclusion criteria for data to be admitted to be studied and extracted is: (1) at what hospital the ERCP, or other procedure, was performed; (2) age of the candidate (i.e., age is greater than 18 years old); and (3) indication of condition (i.e., choledocholithiasis). Exclusion criteria optionally may include: (1) pancreatic pathology intervened upon during procedure; (2) pre-existing sphincterotomy; (3) previous liver transplantation; and (4) previous gastric bypass surgery.

NLP extracted concepts, along with data that are currently stored within templated endoscopy software (Provation® MD Gastroenterology; Wolters Kluwer, Minneapolis, Minn.), can be securely transferred to a health information exchange for storage via Health Level 7 (HL7) messaging. HL7 is a framework for exchange, integration, sharing, and retrieval of electronic health information.

In some embodiments, to ensure the accuracy of extracted data and quality metrics, these extracted data are compared with manual physician review of electronic health records. Manual physician review may comprise one, two, or more gastroenterologists following the US Multi-Society Task Force 2012 Guidelines for Colonoscopy Surveillance after Screening and Polypectomy reviewing unedited patient health records, or records that have been through pre-processing such as NLP. Discrepancies between annotators in the manual physician review can be adjudicated by a third gastroenterologist or other physician.

In another embodiment, a sample size is calculated based on: (1) preliminary data using NLP in another, optionally related, procedure; (2) previous centers' related quality metric accuracies; and (3) doctor experience with related quality concepts.

In one embodiment, a sample size of 200 allows for creation of a training dataset for the NLP engine and allows for a testing set to test for recall, precision, and accuracy of the NLP engine. Data extraction, which identifies a standardized terminology for a disease or process from free-text reports and stored concepts from the templated software, is compared to blinded, paired experts in the treated condition, for example ERCP.

Discrepancies between two independent manual reviewers regarding an electronic health record or pre-processed record can be adjudicated by a third-party physician expert. Accuracy and correlation between the gold standard (manual physician review) and the extraction can then be tested. Analysis, recall, precision, accuracy, and f-measure can be calculated to determine the performance characteristics of information retrieval using the templated and NLP extractions. Cohen's Kappa can also be utilized as a measure of inter-annotator agreement to compare between the three groups (e.g., manual review, template extraction, and NLP extraction). Cohen's kappa coefficient is a statistical measure of inter-rater agreement or inter-annotator agreement for qualitative (categorical) items. In one embodiment, a score greater than 0.8 for Cohen's kappa overall (showing substantial statistical significance) is expected.

Data is optionally captured and processed at two levels within the TRAQME framework: (1) at the individual provider level to track outcome measures over a large region and (2) at the document level to prove that quality metrics can be extracted accurately.

Shown in Table 1, recall, precision, accuracy, and f-measure can be calculated for both testing and training data sets. Recall is defined as: [true positives/(true positives+false negatives)] or (reports in agreement/positive reports by gold standard). Precision is defined as: [true positives/(true positives+false positives)] or (reports in agreement/positive reports by NLP). Accuracy is defined as [(true positives+true negatives)/(true positives+false positives+true negatives+false negatives)]. The f-measure is defined as [2* (precision*recall)/(precision+recall)] and is used for the measurement of information retrieval and measures the effectiveness of retrieval. values for recall, precision, accuracy, and f-measure vary between 0-1 with 1 being the optimal

TABLE 1
Precision, recall, accuracy, and f-measure defined.

| | Formula | What it Tests | Interpretation |
|---|---|---|---|
| Recall^{a} | [true positives/(true positives + | The fraction of retrieved | Ranges from 0-1 |
| | false negatives)] or [reports in | documents that are relevant to the | with 1 being the |
| | agreement/positive reports by | search.³⁴ | most optimal |
| | gold standard] | | |
| Precision^{a} | [true positives/(true positives + | The fraction of the documents that | Ranges from 0-1 |
| | false positives)] or (reports in | are relevant to the query that are | with 1 being the |
| | agreement/positive reports by | successfully retrieved.³⁴ | most optimal |
| | NLP) | | |
| Accuracy^{a} | [(true positives + true negatives)/ | The proportion of true results (both | Ranges from 0-1 |
| | (true positives + false positives + | true positives and true negatives) | with 1 being the |
| | true negatives + false negatives)] | in the population.³⁴ | most optimal |
| F-Measure^{a} | [2 * (precision * recall)/(precision | Used for the measurement of | Ranges from 0-1 |
| | + recall)] | information retrieval and measures | with 1 being the |
| | | the effectiveness of retrieval.³⁴ | most optimal |

^{a}Van Rijsbergen C J. Information Retrieval. 2nd ed: Butterworth; 1979.³⁵

In one embodiment, the combination of NLP and template software extraction achieves an overall accuracy of >90%, based on previous studies in colonoscopy where NLP-based data extraction achieved an overall accuracy of 0.89 compared to manual review.

Extracted data can optionally be sent securely via HL7 messages to GIQuIC, a joint quality repository organized by the American College of Gastroenterology (“ACG”) and ASGE.

The TRAQME framework is intended to operate broadly outside of ERCP and colonoscopy, allowing for: (1) quality dashboards for provider tracking and feedback; (2) inclusion of pathology and radiology NLP extraction; (3) clinical decision support; and (4) reporting to multiple entities.

Thus, herein presented are systems and methods for making clinical recommendations, comprising receiving pathology reports by a computing device; processing the pathology reports by the computing device using natural language processing software, including a custom pathology dictionary; generating, using the computing device, a document based on the processing of the pathology reports; and using the document to output a clinical recommendation.

In a further embodiment, the step of processing the pathology reports further comprises applying pre-processing software analysis to a patient health record.

In another further embodiment, the step of generating a document further comprises applying post-processing software analysis to a patient health record.

In still another further embodiment, the step of using the document further comprises supplying a feedback loop, wherein said feedback loop provides a rule-based clinical surveillance interval to an interested healthcare party selected from the group consisting of: a patient; a doctor; an insurer; a referring provider; and a national quality database reporting center.

In yet another further embodiment, the step of generating a document further comprises using Unified Medical Language System terms, pathology numbers, pathology measurements, and sentence and section breaks from a patient health record.

Finally, in another embodiment, the clinical recommendation is based on the number, size, and location of gastrointestinal carcinomas, tubulovillous adenomas, tubular adenomas, dysplasia, hyperplastic polyps, sessile serrated polyps, and traditional serrated adenomas.

Further presented is a computer implemented system for recommending a clinical surveillance interval comprising pre-processing software analysis of a patient health record, post-processing software analysis of a patient health record, application of clinical recommendation logic through clinical decision support software, and a feedback loop.

In a further embodiment, pre-processing software analysis of the patient health record further comprises natural language processing of a merged document, wherein said merged document comprises a patient health record and a pathology report. In another further embodiment, the information in the merged document is related to gastroenterology. In still another further embodiment, the pre-processing software analysis of the patient health record produces an Extensible Markup Language (“XML”) document. In yet another further embodiment, the post-processing software analysis of the patient health record creates data tables using Unified Medical Language System terms, pathology numbers, pathology measurements, and sentence and section breaks from the patient health record.

In another embodiment, the clinical recommendation logic allows for recommending a clinical surveillance interval based on the number, size, and location of gastrointestinal carcinomas, tubulovillous adenomas, tubular adenomas, dysplasia, hyperplastic polyps, sessile serrated polyps, and traditional serrated adenomas. Finally, in another embodiment, the feedback loop provides a recommended clinical surveillance interval to an interested healthcare party selected from the group consisting of: a patient, a doctor, an insurer, a referring provider, and a national quality database reporting center.

Additionally presented is a computer implemented system for tracking individual care provider deviation from clinical decision support software recommended surveillance intervals comprising software implemented tracking of individual care providers' recommended surveillance intervals, application of clinical recommendation logic through clinical decision support software to patient health records to derive a rule-based surveillance interval, and software implemented comparisons of the individual care providers' recommended surveillance intervals to the rule-based surveillance intervals over time.

In a further embodiment, the system further comprises pre-processing software analysis of a patient health record. In still another embodiment, the system further comprises post-processing software analysis of a patient health record. And in still a further embodiment, the system further comprises a feedback loop, wherein said feedback loop provides a rule-based clinical surveillance interval to an interested healthcare party selected from the group consisting of: a patient; a doctor; an insurer; a referring provider; and a national quality database reporting center.

In yet another embodiment, the post-processing software analysis of the patient health record creates data tables using Unified Medical Language System terms, pathology numbers, pathology measurements, and sentence and section breaks from the patient health record. The rule-based surveillance interval is optionally based on the number, size, and location of gastrointestinal carcinomas, tubulovillous adenomas, tubular adenomas, dysplasia, hyperplastic polyps, sessile serrated polyps, and traditional serrated adenomas. In another embodiment, the surveillance intervals are intermittent periods between gastroenterology exams.

Also shown is a method for tracking individual care provider deviation from clinical decision support software recommended surveillance intervals comprising tracking individual care providers' recommended surveillance intervals, applying clinical recommendation logic through clinical decision support software to patient health records to derive a rule-based surveillance interval, and comparing the individual care providers' recommended surveillance intervals to the rule-based surveillance intervals over time.

### EXAMPLES

At the individual provider level, using a regional health information exchange, failure rates were measured along with other quality outcomes on 130 ERCP providers (gastroenterologists and surgeons) performing 16,968 ERCP's from 2001-2011. This confirmed a positive volume-outcome relationship for ERCP, with the odds of a failed ERCP being two-fold higher for low volume providers (n=111) compared to physicians having moderate (n=15) and high annual procedure volume (n=4).

Additional quality measures, including rates of post-procedure hospitalization and utilization of purely diagnostic ERCP were significantly higher among low volume providers (28.2% and 14.8%, respectively) compared to moderate (24.6% and 12.8%) and high volume physicians (11.0% and 6.9%). These data show that ERCP outcomes can be tracked over a large geographic region using an established health information exchange.

At the document level, cTAKES is an open-source, freely available and configurable NLP engine that was successfully used for identifying and extracting quality metrics and outcome measures from colonoscopy reports. Additionally, cTAKES accurately linked the colonoscopy report with the results of surgical pathology from resected polyps: highest level of pathology (e.g., cancer, advanced adenoma, adenoma), location of lesion, number of adenomas, and size of adenomas.

Table 2 shows further statistics from the cTakes NLP processing of one study.

TABLE 2
Precision, recall, accuracy, and f-measure for colonoscopy/pathology
free text documents from a training and a test set.

| | | Preci- | Re- | Accu- | F- |
|---|---|---|---|---|---|
| | | sion | call | racy | measure |
| Most advanced | None | 0.99 | 0.99 | 98% | .97 |
| lesion | Hyperplastic | 1 | 0.99 | | |
| | polyp | | | | |
| | Tubular adenoma | 0.98 | 0.98 | | |
| | Advanced adenoma | 0.94 | 0.94 | | |
| | Carcinoma | 0.9 | 1 | | |
| Location of | None | 0.94 | 0.99 | 97% | 0.96 |
| most advanced | Proximal | 0.97 | 0.97 | | |
| lesion | Distal | 0.99 | 1 | | |
| | Proximal and | 0.97 | 0.89 | | |
| | distal equal | | | | |
| Largest adenoma | None | 0.94 | 0.99 | 96% | .96 |
| removed | <=5 mm | 0.97 | 0.95 | | |
| | 6-9 mm | 0.95 | 0.93 | | |
| | >=10 mm | 0.99 | 0.93 | | |
| Number of | 0 | 1 | 0.96 | 84% | .68 |
| adenomas | 1-2 | 0.86 | 0.82 | | |
| removed | 3-10 | 0.61 | 0.65 | | |
| | >10 | 0.18 | 0.38 | | |

* Precision, recall, accuracy, and F-measure for extraction of specific measurements from full text documents using. This shows that the extraction for the desired measures varied between 84-98%

In one experiment, to create a gold standard surveillance interval, or baseline to which to compare analysis from TRAQME, 300 random screening documents related to colonoscopies showing pathologies were chosen. Two gastroenterologists reviewed the information independently, and provided surveillance recommendations for patients. The surveillance intervals to be recommended were broken into (1) 10 years, (2) 5-10 years, (3) 3 years, (4) 1-3 years, and (5) a physician required for the decision. In other embodiments, other surveillance intervals could be used. When the two physicians agreed, this was considered gold standard, and if there was a disagreement, an independent third gastroenterologist decided, and this was considered gold standard.

In another experiment, to determine NLP accuracy, 300 random screening documents related to colonoscopies showing pathologies were chosen. The documents were processed with NLP software, and output information into categories including: (1) Most advanced lesion; (2) Location of the most advanced legion; (3) Largest adenoma removed; (4) Number of adenomas removed; (5) Hemorrhoids; and (6) Diverticulosis. Two gastroenterologists reviewed the information output by the NPL software independently, and provided surveillance recommendations for patients. The surveillance intervals to be recommended were broken into (1) 10 years, (2) 5-10 years, (3) 3 years, (4) 1-3 years, and (5) a physician required for the decision. When the two physicians agreed, this was considered gold standard, and if there was a disagreement, an independent third gastroenterologist decided, and that decision was considered gold standard.

In a third experiment, 300 random screening documents related to colonoscopies showing pathologies were chosen, and the documents were processed with NLP software, and the output information was separated into categories including: (1) Most advanced lesion; (2) Location of the most advanced legion; (3) Largest adenoma removed; (4) Number of adenomas removed; (5) Hemorrhoids; and (6) Diverticulosis. The output information was then processed through the TRAQME system and clinical decision support logic. The same 300 documents were processed via the gold standard described above (doctor review of the health records) and the NLP only methodology described above.

The results of the experiments showed a high correlation between the clinical decision support processed documents (TRAQME) and the gold standard of physician review of the text documents (both original documents and NLP processed documents). There was a strong to substantial correlation between paired manual gastroenterologist review and a fully automated system. There were no errors between NLP based manual review and the CDS logic system. A majority of “missed” intervals were due to NLP error or not accounting for certain clinical scenarios and/or terms.

The experiments show that NLP with CDS logic is a promising technology for quality tracking in endoscopy for surveillance interval compliance. This system implemented broadly could individually track and report compliance to guideline based surveillance intervals to providers, payers, or other interested parties.

For example, Table 3 above shows that for recommending surveillance at 10 years out (10 Y) the CDS logic recommended this in 108 cases, while the Gold Standard (physician review based on guidelines) recommended this in 109 cases. This is shown by reading vertically down a column for the Gold Standard (e.g., for Gold Standard 10 Y read only vertically down, and for CDS 10 Y read only horizontally across to the highlighted block). Thus, the TRAQME CDS logic was 99.1% accurate for the 10 year recommended interval. At the 5-10 year interval, the Gold Standard total reading vertically down the 5-10 Y column shows 91 total; however, the CDS 5-10 Y recommendation reading across horizontally to the highlighted 78 shows that for the 5-10 Y interval, the CDS logic was 85.7% accurate (78/91).

In one example for analysis of a free text document, more specifically, a merged document with findings, impression, specimen, and pathology headings, DOCID: 3665009 is provided below in quotations.

“DOCID: 3665009 FINDINGS: The perianal and digital rectal examinations were normal. A sessile polyp was found in the cecum. The polyp was 3 mm in size. The polyp was removed with a cold forceps. Resection and retrieval were complete. A sessile polyp was found in the ascending colon. The polyp was 1 mm in size. The polyp was removed with a cold forceps. Resection and retrieval were complete. A sessile polyp was found at the splenic flexure. The polyp was 5 mm in size. The polyp was removed with a cold snare. Resection and retrieval were complete. A sessile polyp was found in the descending colon. The polyp was 4 mm in size. The polyp was removed with a cold snare. Resection and retrieval were complete. Multiple sessile polyps (approximately 33) were found in the recto-sigmoid colon. The polyps were 1 to 6 mm in size. These polyps were removed with a cold snare hot snare and cold forceps. Resection and retrieval were complete. Internal non-bleeding medium-sized hemorrhoids were found during retroflexion. IMPRESSION: A 3 mm polyp in the cecum. Resected and retrieved. A 1 mm polyp in the ascending colon. Resected and retrieved. A 5 mm polyp in the splenic flexure. Resected and SPECIMEN: 1-CECUM POLYP 2-ASCENDING COLON POLYP 3-SPLENIC FLEXURE POLYP 4-DESCENDING COLON POLYP 5-RECTO-SIGMOID COLON POLYPS PATHOLOGY: COLON CECUM POLYPECTOMY: TUBULAR ADENOMA. COLON ASCENDING POLYPECTOMY: HYPERPLASTIC POLYP. COLONSPLENIC FLEXURE POLYPECTOMY: HYPERPLASTIC POLYP. COLON DESCENDING POLYPECTOMY: COLONIC MUCOSA WITH NO EVIDENCE OF POLYP. COLON RECTO-SIGMOID POLYPECTOMY: MULTIPLE FRAGMENTS OF HYPERPLASTIC POLYPS SUGGESTIVE OF SESSILE SERRATED ADENOMA. ONE FRAGMENT OF TUBULAR ADENOMA.”

In one exemplary embodiment, the text in the above merged document would undergo pre-processing and post-processing in the TRAQME framework according to the process shown in FIG. 5. However, other pre and post-processing processes to organize the data provided by one or more merged documents are also envisioned.

Referring now to Table 4, a table created during the post-processing stage is shown, wherein ail numbers (written as either numerals or words) found in the merged document above by NLP in pre-processing, with their beginning and ending location in the merged document, are provided. These numbers are derived from a unique Extensible Markup Language (“XML”) document created from the free text document.

TABLE 4
All numbers derived from XML document
after natural language processing.

| Key | Random_ID | Begin | End | Num |
|---|---|---|---|---|
| 505 | 3665009 | 138 | 139 | 3 |
| 506 | 3665009 | 298 | 299 | 1 |
| 507 | 3665009 | 458 | 459 | 5 |
| 508 | 3665009 | 617 | 618 | 4 |
| 509 | 3665009 | 750 | 752 | 33 |
| 510 | 3665009 | 809 | 810 | 1 |
| 511 | 3665009 | 814 | 815 | 6 |
| 512 | 3665009 | 1033 | 1034 | 3 |
| 513 | 3665009 | 1084 | 1085 | 1 |
| 514 | 3665009 | 1145 | 1146 | 5 |
| 515 | 3665009 | 1204 | 1205 | 1 |
| 516 | 3665009 | 1218 | 1219 | 2 |
| 517 | 3665009 | 1242 | 1243 | 3 |
| 518 | 3665009 | 1266 | 1267 | 4 |
| 519 | 3665009 | 1291 | 1292 | 5 |
| 520 | 3665009 | 1664 | 1667 | 1 |

In one embodiment, during pre-processing, colonoscopy reports are merged with their associated pathology reports into a single merged document. Reports without associated pathology are removed. Each document is run through a cTakes Pipeline outputting a single XML document each. The cTakes pipeline utilizes the built in unified medical language system (“UMLS”) lookup dictionary to identify terms in standardized format (“CUIs”). Optionally, a small custom dictionary is used to identify some terms that are not recognized by the built in UMLS lookup dictionary. Negation of terms is identified as well as the sentence and section of each term. Numbers and measurements are identified separately.

In another embodiment, XML documents produced during pre-processing are imported into a local database during post-processing. Numbers written as words (e.g., “two”) are converted into integers (e.g., “2”). There can be table entries for: UMLS Terms (“CUIs”), numbers, measurements, and sentence and section breaks. In one exemplary embodiment, the post-processing analysis is performed for each document as follows.

For each pathology found, ignoring the negated terms in the pathology section, if dysplasia pathology is found, the text is searched earlier in the same sentence for condyloma. If this is identified, the finding is ignored. Next, the text is searched to the left of the identified pathology in the text for the first location found. This is then written to a pathology table, in one embodiment a polyp and its location. If more than one pathology item is found in the same location, only the worst one is saved to the table.

For each measurement found in the Findings section, if the units are not in mm or cm, it is ignored. If the term lipoma is in the same sentence as the measurement, it is ignored. If a measurement is >50 mm, then the measurement is ignored. Otherwise, the text units to the left of the measurement are searched to find the location of the measurement in the body. The measurement is matched to the pathology using the location, and then added to a polyp or pathology table as the size of the identified pathology. If a measurement is ≧10 mm and the identified pathology is an adenoma, it is upgraded to an advanced adenoma in the polyp table. If more than one measurement is found for the same location, only the largest measurement is saved to the table.

For each number that wasn't identified as a measurement in the Findings section, the text units to the right of the number are searched. This number is matched to the pathology using the location and added to the polyp table as the quantity of the identified pathology. If more than one quantity is found for the same location, only the largest quantity is saved to the table.

The post-processing step optionally includes writing a key table. If non-negated hemorrhoids are identified in the document, this is noted in the key table. If non-negated diverticulosis is identified in the document, this is noted in the key table. Next, the polyp table is searched to identify the highest level of pathology, and this is the worst lesion in the key table. Next, the worst lesion is identified as proximal, distal, or both. This is the location of the worst lesion. Next, the adenomas are searched for the largest size. This is the largest adenoma in the key table. The sum of the number of polyps identified as adenomas is reported that as the number of adenomas.

In one embodiment, the following logic is applied to the key table, optionally as software. If there is a carcinoma, this returns a surveillance instruction to discuss with patient. For advanced adenomas, with 1-9, the procedure should be repeated in 3 years, and with 10 or more adenomas, the procedure should be repeated in 1-3 years, optionally with genetic testing. For adenomas, with 1-2, the procedure should be repeated in 5-10 years, for 3-9 adenomas, the procedure should be repeated in 3 years, and for 10 or more adenomas, the procedure should be repeated in 1-3 years, optionally with genetic testing. For a hyperplastic polyp, the procedure should be repeated in 10 years. Finally, for a value in the key table of “no worst lesion,” the returned surveillance interval should be 10 years.

Referring now to Table 5, a table created during the post-processing stage is shown, wherein all of the sentences and headings from the merged document above are separated and assigned to a section, along with their beginning and ending location in the merged document.

TABLE 5
Sentence and section breaks derived from XML
document after natural language processing.

| Key | Random_ID | Begin | End | Number | Section | Sentence |
|---|---|---|---|---|---|---|
| 1325 | 3665009 | 0 | 14 | 0 | DOCID | DOCID: 3665009 |
| 1326 | 3665009 | 16 | 25 | 1 | FINDINGS | FINDINGS: |
| 1327 | 3665009 | 26 | 83 | 2 | FINDINGS | The perianal and digital rectal |
| | | | | | | examinations were normal. |
| 1328 | 3665009 | 84 | 123 | 3 | FINDINGS | A sessile polyp was found in the cecum. |
| 1329 | 3665009 | 124 | 151 | 4 | FINDINGS | The polyp was 3 mm in size. |
| 1330 | 3665009 | 152 | 194 | 5 | FINDINGS | The polyp was removed with a cold |
| | | | | | | forceps. |
| 1331 | 3665009 | 195 | 233 | 6 | FINDINGS | Resection and retrieval were complete. |
| 1332 | 3665009 | 234 | 283 | 7 | FINDINGS | A sessile polyp was found in the |
| | | | | | | ascending colon. |
| 1333 | 3665009 | 284 | 311 | 8 | FINDINGS | The polyp was 1 mm in size. |
| 1334 | 3665009 | 312 | 354 | 9 | FINDINGS | The polyp was removed with a cold |
| | | | | | | forceps. |
| 1335 | 3665009 | 355 | 393 | 10 | FINDINGS | Resection and retrieval were complete. |
| 1336 | 3665009 | 394 | 443 | 11 | FINDINGS | A sessile polyp was found at the splenic |
| | | | | | | flexure. |
| 1337 | 3665009 | 444 | 471 | 12 | FINDINGS | The polyp was 5 mm in size. |
| 1338 | 3665009 | 472 | 512 | 13 | FINDINGS | The polyp was removed with a cold |
| | | | | | | snare. |
| 1339 | 3665009 | 513 | 551 | 14 | FINDINGS | Resection and retrieval were complete. |
| 1340 | 3665009 | 552 | 602 | 15 | FINDINGS | A sessile polyp was found in the |
| | | | | | | descending colon. |
| 1341 | 3665009 | 603 | 630 | 16 | FINDINGS | The polyp was 4 mm in size. |
| 1342 | 3665009 | 631 | 671 | 17 | FINDINGS | The polyp was removed with a cold |
| | | | | | | snare. |
| 1343 | 3665009 | 672 | 710 | 18 | FINDINGS | Resection and retrieval were complete. |
| 1344 | 3665009 | 711 | 792 | 19 | FINDINGS | Multiple sessile polyps (approximately 33) |
| | | | | | | were found in the recto-sigmoid colon. |
| 1345 | 3665009 | 793 | 827 | 20 | FINDINGS | The polyps were 1 to 6 mm in size. |
| 1346 | 3665009 | 828 | 899 | 21 | FINDINGS | The polyps were removed with a cold |
| | | | | | | snare hot snare and cold forceps. |
| 1347 | 3665009 | 900 | 938 | 22 | FINDINGS | Resection and retrieval were complete. |
| 1348 | 3665009 | 939 | 1017 | 23 | FINDINGS | Internal non-bleeding medium-sized |
| | | | | | | hemorrhoids were found during |
| | | | | | | retroflexion |
| 1349 | 3665009 | 1019 | 1030 | 24 | IMPRESSION | IMPRESSION: |
| 1350 | 3665009 | 1031 | 1057 | 25 | IMPRESSION | A 3 mm polyp in the cecum. |
| 1351 | 3665009 | 1058 | 1081 | 26 | IMPRESSION | Resected and retrieved. |
| 1352 | 3665009 | 1082 | 1118 | 27 | IMPRESSION | A 1 mm polyp in the ascending colon. |
| 1353 | 3665009 | 1119 | 1142 | 28 | IMPRESSION | Resected and retrieved. |
| 1354 | 3665009 | 1143 | 1179 | 29 | IMPRESSION | A 5 mm polyp in the splenic flexure. |
| 1355 | 3665009 | 1180 | 1192 | 30 | IMPRESSION | Resected and |
| 1356 | 3665009 | 1194 | 1203 | 31 | SPECIMEN | SPECIMEN: |
| 1357 | 3665009 | 1204 | 1319 | 32 | SPECIMEN | 1-CECUM POLYP 2-ASCENDING |
| | | | | | | COLON POLYP 3-SPLENIC FLEXURE |
| | | | | | | POLYP 4-DESCENDING COLON |
| | | | | | | POLYP 5-RECTO-SIGMOID COLON |
| | | | | | | POLYPS |
| 1358 | 3665009 | 1321 | 1331 | 33 | PATHOLOGY | PATHOLOGY: |
| 1359 | 3665009 | 1332 | 1373 | 34 | PATHOLOGY | COLON CECUM POLYPECTOMY: |
| | | | | | | TUBULAR ADENOMA. |
| 1360 | 3665009 | 1374 | 1422 | 35 | PATHOLOGY | COLON ASCENDING POLYPECTOMY: |
| | | | | | | HYPERPLASTIC POLYP. |
| 1361 | 3665009 | 1423 | 1476 | 36 | PATHOLOGY | COLONSPLENIC FLEXURE |
| | | | | | | POLYPECTOMY: HYPERPLASTIC |
| | | | | | | POLYP. |
| 1362 | 3665009 | 1477 | 1548 | 37 | PATHOLOGY | COLON DESCENDING |
| | | | | | | POLYPECTOMY: COLONIC MUCOSA |
| | | | | | | WITH NO EVIDENCE OF POLYP. |
| 1363 | 3665009 | 1549 | 1663 | 38 | PATHOLOGY | COLON RECTO-SIGMOID |
| | | | | | | POLYPECTOMY: MULTIPLE |
| | | | | | | FRAGMENTS OF HYPERPLASTIC |
| | | | | | | POLYPS SUGGESTIVE OF SESSILE |
| | | | | | | SERRATED ADENOMA. |
| 1364 | 3665009 | 1664 | 1696 | 39 | PATHOLOGY | ONE FRAGMENT OF TUBULAR |
| | | | | | | ADENOMA. |

Referring now to Table 6, a table created during the post-processing stage is shown, wherein all of the numbers identified as measurements in the merged document text shown above are combined into a table.

TABLE 6
Measurement numbers derived from XML document
after natural language processing.

| Key | Random_ID | Begin | End | Num | Units |
|---|---|---|---|---|---|
| 136 | 3665009 | 138 | 142 | 3 | mm |
| 137 | 3665009 | 298 | 302 | 1 | mm |
| 138 | 3665009 | 458 | 462 | 5 | mm |
| 139 | 3665009 | 617 | 621 | 4 | mm |
| 140 | 3665009 | 814 | 818 | 6 | mm |
| 141 | 3665009 | 1033 | 1037 | 3 | mm |
| 142 | 3665009 | 1084 | 1088 | 1 | mm |
| 143 | 3665009 | 1145 | 1149 | 5 | mm |

Referring now to Table 7, an example pathology summary table is shown, and in the embodiment shown the pathologies are polyps.

TABLE 7
Pathology table derived from XML document after natural language processing.

| Key | Random_ID | Worst_Lesion | Location | LocationCat | Largest_Polyp | Num_Polyps |
|---|---|---|---|---|---|---|
| 111 | 3665009 | 2 | Cecum | 1 | 3 | |
| 112 | 3665009 | 1 | Ascending Colon | 1 | 1 | |
| 113 | 3665009 | 2 | Sigmoid Colon | 2 | 6 | 33 |
| 114 | 3665009 | | Descending Colon | 2 | 4 | |
| 115 | 3665009 | | Splenic Fixture | 1 | 5 | |

Referring now to Table 8, an example key table is shown. hi the embodiment shown, the key table is used to aggregate the pathologies from the XML document, such as adenomas, to use in the clinical decision support logic. In one embodiment the logic is as follows: (1) Worst Lesion: 0=>‘None’; 1=>‘Hyperplastic Polyp’: 2=>‘Tubular Adenoma’: 3=>‘Advanced Adenoma’: 4=>‘Carcinoma’ (2) Location: 0=>‘None’; 1=>‘Proximal’: 2=>‘Distal’; 3=>‘Proximal and Distal Equal’ (3) Largest Adenoma: 0=>‘None’:1<‘>=5 mm (Diminutive)’; 2=>‘6-9 mm (Small)’; 3=22 ‘>=10 mm (Large)’ (4) Number of Adenomas Removed: 0=>‘0’; 1=>‘1-2’; 2=>‘3-10’; 3=>‘>10’; (5) Hemorrhoids: 0=>False; 1=>True (6) Diverticulosis: 0=>False; 1=>True (7) CDSS Follow Up: 0=>‘Repeat in 10 years’; 1=>‘Repeat in 5-10 years’; 2=>‘Repeat in 3 years’; 3=>‘Repeat in 1-3 years, Consider Genetic Testing’; 4=>‘Physician Decision’.

TABLE 8
Key table derived from XML document after natural language processing.

| Key | Random_ID | Worst_Lesion | Location | Largest_Adenoma | Num_Adenomas | Hemorrhoids | Diverticulosis |
|---|---|---|---|---|---|---|---|
| 60 | 3665009 | 2 | 3 | 2 | 3 | 1 | 0 |

Referring now to Table 9, the table shows the location of the original terms in the free text document (with “Begin” and “End”), and shows the associated GUI and associated terms from the universal medical language system under “Name”. If the term is negated by a “no” in the free text document, then a 1 would appear in the negation column to remove the term from later analysis by the clinical decision support software logic.

TABLE 9
UMLS table derived from XML document after natural language processing.

| Key | Random_ID | Begin | End | Original_Term | Scheme | CUI | Name | Negated |
|---|---|---|---|---|---|---|---|---|
| 9632 | 3665009 | 16 | 24 | FINDINGS | SNOMED | C0243095 | Finding | 0 |
| 9633 | 3665009 | 16 | 24 | FINDINGS | SNOMED | C0037088 | Signs and | 0 |
| | | | | | | | Symptoms | |
| 9634 | 3665009 | 16 | 24 | FINDINGS | SNOMED | C0037088 | Signs and | 0 |
| | | | | | | | Symptoms | |
| 9635 | 3665009 | 16 | 24 | FINDINGS | SNOMED | C0037088 | Signs and | 0 |
| | | | | | | | Symptoms | |
| 9619 | 3665009 | 43 | 70 | digital rectal | SNOMED | C1384593 | Digital Rectal | 0 |
| | | | | examinations | | | Examination | |
| 9620 | 3665009 | 43 | 70 | digital rectal | SNOMED | C0199220 | Digital | 0 |
| | | | | examinations | | | Palpatation | |
| 9621 | 3665009 | 43 | 70 | digital rectal | SNOMED | C0199220 | Digital | 0 |
| | | | | examinations | | | Palpatation | |

In a large-scale application of the technology of the present disclosure, data from 13 Veterans Affairs (“VA”) endoscopy units, were used to validate the performance of a NLP-based system for quantifying ADR and for identifying the requisite variables for providing guideline-based surveillance recommendations. The study was approved by the VA Central Institutional Review Board. Data were obtained from thirteen VA medical centers by electronic retrieval from the Computerized Patient Record System (“CPRS”), the VA electronic medical record. Extracted data included colonoscopy and, when applicable, pathology reports from Veterans aged 40-80 years undergoing first-time VA-based colonoscopy between 2002 and 2009 for any indication except neoplasia surveillance. Extracted reports were linked using study-specific software to their corresponding pathology reports and were de-identified for NLP analysis.

In the study, exclusion criteria for colonoscopy/pathology reports included: (1) previous VA-based colonoscopy for any indication within the 8-year interval; (2) colonoscopy indication of neoplasia surveillance; (3) previous colon resection; (4) history of polyps or cancer of the colon or rectum; (5) history of inflammatory bowel disease; and (6) history of hereditary polyposis or non-polyposis colorectal cancer syndrome. AH potentially eligible colonoscopies underwent pre-processing of the colonoscopy report using a text search of the indication field of the report with the terms “surveillance”, “history of adenoma”, “history of polyp”, and were excluded if these terms were present. Associated International Classification of Diseases, 9^{th} revision (“ICD9”) codes were then searched within the documents for V12.72 (personal history of colonic polyps), 211.3 (benign neoplasm of colon), 211.4 (benign neoplasm of rectum and anal canal), and 153.* (malignant neoplasm of colon). Documents with any of these terms were excluded.

ADR, the best current method of tracking colonoscopy quality, was easily calculated across 13 distinct medical centers irrespective of screening or surveillance status. With more specific measures of colonoscopy quality (average number of adenomas per screening colonoscopy) granular metrics could allow for further refinement of quality measurement of colonoscopy performance. Based on the study presented below, despite significant geographic variation within a single, large, integrated health care system, a NLP system accurately identified the necessary components for both quality tracking and automated surveillance guideline creation.

Integration of this system into a functional electronic health record system could allow for direct clinician (primary and sub-specialty) interaction with the derived data for patient management and a more tailored quality measurement in colonoscopy.

Each patient-related report was given a unique ID for tracking and blinding the investigators to patient identity and VA location. Text reports were combined prior to NLP processing by merging the “Findings” and “Impression” sections and combining them with pathology. This is part of a pre-processing stage, as described further below with regard to FIG. 5. An example of such a merged document from another example is displayed in Table 5 above.

The Apache Software Foundation cTAKES version 3.1.1 was utilized as the NLP engine for examination of colonoscopy and pathology reports. As noted, cTAKES is an open-source, NLP system that uses rule-based and machine learning methods with multiple components for customization. Machine learning methods included, but are not limited to: (1) sentence boundary detection (e.g., Table 5), (2) tokenization (dividing a sentence into unique words) (e.g., FIGS. 13-15), (3) named entity recognition using the UMLS (e.g., Table 9), and (4) negation (e.g., recognizing “no adenoma” as the absence of an adenoma) (e.g., Table 9). Additionally, a custom dictionary was created for synonyms not identified within UMLS and for additional post-processing of common expressions.

Documents were stored within MySQL version 5.5.36 software, an open-source database released under the General Public License (GNU), version 2.0. Using the MySQL (RAND( )) function, 750 combined or merged reports were selected from the 42,569 eligible for annotation (those reports containing a pathology portion) to create a reference standard for training and testing. The 750 annotated documents were randomly split in a 2-to-1 ratio, allocating 250 documents to the training set (documents to be reviewed by the investigators for NLP refinement) and 500 documents to the test set.

One outcome was NLP system accuracy to identify the necessary components for high quality, guideline adherent, surveillance recommendations from colonoscopy and pathology reports, including detection of adenomas. ADR among institutions was another outcome.

Terms for each concept were agreed upon a priori. Each unique colonoscopy report was categorized into nine categories: (1) adenocarcinoma, (2) advanced adenoma, (3) advanced sessile serrated polyp/adenoma (SSP), (4) non-advanced acenoma, (6) non-advanced SSP, (7) ≧10 mm hyperplastic polyp (HP), (8) <10 mm HP and (9) non-significant. For exemplary categorizations, see also FIGS. 6-8 and 17.

Cancer was defined as an adenocarcinoma of the colon or rectum. An advanced adenoma (“AA”) was defined as a polyp or lesion with villous histology, carcinoma-in-situ, high-grade dysplasia, or maximal dimension of ≧10 mm. Advanced sessile serrated polyps (“SSP's”) were defined as SSP's with dysplasia, a traditional serrated adenoma, or a SSP with size on colonoscopy report ≧10 mm. Large hyperplastic polyps were defined as a hyperplastic polyp 10 mm. For all lesions, size was determined by the endoscopist. Non-significant findings included lipomas, benign colonic tissue, lymphoid follicles, or no specimen for pathologic review.

Location was categorized as: 1) proximal (cecum to and including splenic flexure), 2) distal (descending colon to and including the rectum), and 3) both proximal and distal.

Counts were completed for the total number of adenomas and hyperplastic polyps removed. Based on a previous study of correlation of surveillance recommendations, identification of a mass lesion was included as a concept to identify regardless of whether there was a finding of adenocarcinoma. Bowel preparation was not included due to truncation of the document from de-identification.

Five board certified gastroenterologists participated in creation of the reference standard, which was created by a secure online annotation system that randomly allocated the previously randomly selected 750 documents into 300 documents per annotator. This system paired the annotators in a blinded manner such that each document was reviewed by two annotators. The annotators were asked to identify 19 specific concepts (see e.g., FIGS. 6-8) related to the combined reports. If there was disagreement between paired annotators for any concepts, a third, previously randomly-allocated adjudicator reviewed the discrepancies and made a final determination of the best response while remaining blinded to the original annotators' responses. During adjudication, the expert was asked to identify the reason for the discrepancy (e.g., discrepancy between pathology level, location, adenoma counts).

The 750 annotated documents were then randomized 2-to-1 by the MySQL randomize function for training (n=250) and test sets (n=500). The 250 training documents were utilized for custom rule-based content measure answering and were available for investigator exploration. The NLP system was then run over the unselected records (for a total of n=42,569) to assess consistency with non-annotated reports. FIG. 18, described further below, shows how the study sample was determined.

Recall, precision, accuracy, and f-measure were calculated for both training and test sets. Recall, a statistical measure similar to sensitivity, was defined as: reports in agreement+positive reports according to the reference standard. Precision, a statistical measure for NLP similar to positive predictive value (PPV), was defined as: reports in agreement+positive reports by NLP. Accuracy was defined as: (true positives+true negatives)+(true positives+false positives+true negatives+false negatives)

The f-measure was defined as: 2 (precision×recall)+(precision+recall) and is used to quantify the effectiveness of information retrieval. Values for recall, precision, accuracy, and f-measure vary between 0-1, with 1 being optimal.

McNemar's test for paired comparisons was used to compare NLP and annotator error rates among the 500 test documents. Obuchowski's adjustment to McNemar's test for clustered data was used to compare the error rates between NLP and annotators for all 9,500 content points (i.e., [500 reports×19 content points per report]) within the test set. Chi-square tests were used to compare pathology among the training, test, and non-annotated sets. Hochberg's step-up Bonferroni method was used to adjust for multiple comparisons.

A post-hoc analysis by an investigator was conducted for evaluation of reasoning for errors in the NLP system on the test documents only. Evaluation of unsuitable documents, those for which no answer could be obtained from the text report (e.g., no location specified in either the procedure or pathology document), was performed to create an adjusted reference standard.

Now, turning to the results of the experiment, of 96,365 unique subject reports, 1,804 (1.9%) were excluded by secondary text search due to surveillance indications. 94,561 reports met study inclusion criteria and were used as the denominator for ADR. Of these, 51,992 (55.0%) had no associated pathology (e.g., no biopsy done during procedure), leaving 42,569 to be processed by NLP. The 13 VA sites averaged 3,274.54±1961.1 (range, 1,012-6,995) colonoscopies per site.

Seven hundred and fifty documents contained 14,250 unique data points for training and testing and were successfully annotated and adjudicated. There were 176 (23.5%) documents with 252 (1.8%) discrepant content points resulting from paired annotation. Adjudicated analysis of paired-annotation error discrepancies were due to location (proximal vs. distal) in 71 (9.5%) cases; to the most advanced pathology in 61 (8.1%) (e.g., adenoma versus advanced adenoma); to counting in 59 (7.9%) (e.g., number of adenomas); and to insufficient data to provide a correct answer in 15 (2.0%) (e.g., adenoma with no size measurement). The training and test sets were similar in pathologic spectrum. Table 10 compares training and test sets with the non-annotated set for frequency and location of most advanced finding. There were no differences overall between annotated and non-annotated sets. The only statistically significant differences were location of proximal advanced adenoma and unspecified location for non-advanced adenoma, both of which were higher for the non-annotated set (Table 10). The training set showed high accuracy across the 19 annotated content measures.

TABLE 10
Comparison of testing, training, and non-annotated data sets for
presence and location of most advanced pathology.

| | | Training Set* | | | Testing Set* | | | Non-annotated Set** | | | |
|---|---|---|---|---|---|---|---|---|---|---|---|
| | | n = 250 | | | n = 500 | | | n = 41,819 | | | Adjusted |
| Pathologic Finding | | N | % (95% C.I) | | n | % (95% C.I) | | n | % (95% C.I) | | p-value |
| Cancer | Overall | 8 | 3.2 | (1.4, 6.2) | 17 | 3.4 | (2.0, 5.4) | 1,146 | 2.7 | (2.6, 2.9) | 0.893 |
| | Proximal | 4 | 1.6 | (0.4, 4.1) | 10 | 2.0 | (1.0, 3.7) | 405 | 1.0 | (0.9, 1.1) | 0.248 |
| | only | | | | | | | | | | |
| | Distal | 4 | 1.6 | (0.4, 4.1) | 7 | 1.4 | (0.6, 2.9) | 647 | 1.5 | (1.4, 1.7) | 0.963 |
| | only | | | | | | | | | | |
| | Both | 0 | 0.0 | (0.0, 1.5) | 0 | 0.0 | (0.0, 1.5) | 19 | 0.0 | (0.0, 0.1) | 0.948 |
| | Not | 0 | 0.0 | (0.0, 1.5) | 0 | 0.0 | (0.0, 1.5) | 75 | 0.2 | (0.1, 0.2) | 0.859 |
| | specified | | | | | | | | | | |
| Advan. | Overall | 51 | 20.4 | (15.6, 25.9) | 97 | 19.4 | (16.0, 23.1) | 7,168 | 17.1 | (16.8, 17.5) | 0.707 |
| adenoma | | | | | | | | | | | |
| | Proximal | 22 | 8.8 | (5.6, 13.0) | 46 | 9.2 | (6.8, 12.1) | 2,465 | 5.9 | (5.7, 6.1) | 0.009 |
| | only | | | | | | | | | | |
| | Distal | 23 | 9.2 | (5.9, 13.5) | 45 | 9.0 | (6.6, 11.9) | 4,011 | 9.6 | (9.3, 9.9) | 0.963 |
| | only | | | | | | | | | | |
| | Both | 6 | 2.4 | (0.9, 5.2) | 6 | 1.2 | (0.4, 2.6) | 563 | 1.3 | (1.2, 1.5) | 0.948 |
| | Not | 0 | 0.0 | (0.0, 1.5) | 0 | 0.0 | (0.0, 0.7) | 129 | 0.3 | (0.3, 0.4) | 0.859 |
| | specified | | | | | | | | | | |
| Non- | Overall | 140 | 56.0 | (49.6, 62.3) | 273 | 54.6 | (50.1, 59.0) | 23,264 | 55.6 | (55.2, 56.1) | 0.893 |
| advan. | | | | | | | | | | | |
| adenoma | Proximal | 72 | 28.8 | (23.3, 34.8) | 126 | 25.2 | (21.5, 29.3) | 10,553 | 25.2 | (24.8, 25.7) | 0.674 |
| | only | | | | | | | | | | |
| | Distal | 41 | 16.4 | (12.0, 21.6) | 92 | 18.4 | (15.1, 22.1) | 8,257 | 19.7 | (19.4, 20.1) | 0.963 |
| | only | | | | | | | | | | |
| | Both | 27 | 10.8 | (7.2, 15.3) | 55 | 11.0 | (8.4, 14.1) | 3,523 | 8.4 | (8.2, 8.7) | 0.300 |
| | Not | 0 | 0.0 | (0.0, 1.5) | 0 | 0.0 | (0.0, 0.7) | 931 | 2.2 | (2.1, 2.4) | 0.001 |
| | specified | | | | | | | | | | |
| Advan. | Overall | 0 | 0.0 | (0.0, 1.5) | 1 | 0.2 | (0.0, 1.1) | 107 | 0.3 | (0.2, 0.3) | 0.893 |
| sessile | Proximal | 0 | 0.0 | (0.0, 1.5) | 0 | 0.0 | (0.0, 0.7) | 44 | 0.1 | (0.1, 0.1) | 0.678 |
| serrated | only | | | | | | | | | | |
| polyp | Distal | 0 | 0.0 | (0.0, 1.5) | 1 | 0.2 | (0.0, 1.1) | 57 | 0.1 | (0.1, 0.1) | 0.963 |
| | only | | | | | | | | | | |
| | Both | 0 | 0.0 | (0.0, 1.5) | 0 | 0.0 | (0.0, 0.7) | 6 | 0.0 | (0.0, 0.0) | 0.948 |
| | Not | 0 | 0.0 | (0.0, 1.5) | 0 | 0.0 | (0.0, 0.7) | 0 | 0.0 | (0.0, 0.0) | — |
| | specified | | | | | | | | | | |
| Non- | Overall | 5 | 2.0 | (0.7, 4.6), | 11 | 2.2 | (1.1, 3.9) | 441 | 1.1 | (1.0, 1.2) | 0.120 |
| advan. | Proximal | 1 | 0.4 | (0.0, 2.2) | 4 | 0.8 | (0.2, 2.0) | 179 | 0.4 | (0.4, 0.5) | 0.674 |
| Sessile | only | | | | | | | | | | |
| serrated | Distal | 4 | 1.6 | (0.4, 4.1) | 7 | 1.4 | (0.6, 2.9) | 227 | 0.5 | (0.5, 0.6) | 0.023 |
| Polyp | only | | | | | | | | | | |
| | Both | 0 | 0.0 | (0.0, 1.5) | 0 | 0.0 | (0.0, 0.7) | 18 | 0.0 | (0, 0, 0.1) | 0.948 |
| | Not | 0 | 0.0 | (0.0, 1.5) | 0 | 0.0 | (0.0, 0.7) | 17 | 0.0 | (0.0, 0.1) | 0.859 |
| | specified | | | | | | | | | | |
| ≧10 mm | Overall | 5 | 2.0 | (0.7, 4.6) | 8 | 1.6 | (0.7, 3.1) | 1,481 | 3.5 | (3.4, 3.7) | 0.164 |
| hyper- | Proximal | 4 | 1.6 | (0.4, 4.1) | 2 | 0.4 | (0.1, 1.4) | 395 | 0.9 | (0.8, 1.0) | 0.674 |
| plastic | only | | | | | | | | | | |
| polyp | Distal | 1 | 0.4 | (0.0, 2.2) | 5 | 1.0 | (0.3, 2.3) | 1,052 | 2.5 | (2.4, 2.7) | 0.060 |
| | only | | | | | | | | | | |
| | Both | 0 | 0.0 | (0.0, 1.5) | 1 | 0.2 | (0.0, 1.1) | 34 | 0.1 | (0.1, 0.1) | 0.948 |
| | Not | 0 | 0.0 | (0.0, 1.5) | 0 | 0.0 | (0.0, 0.7) | 0 | 0.0 | (0.0, 0.0) | — |
| | specified | | | | | | | | | | |
| <10 mm | Overall | 102 | 40.8 | (34.7, 47.2) | 193 | 38.6 | (34.3, 43.0) | 15,141 | 36.2 | (35.8, 36.7) | 0.707 |
| Hyper- | | | | | | | | | | | |
| plastic | Proximal | 19 | 7.6 | (4.6, 11.6) | 32 | 6.4 | (4.4, 8.9) | 2,435 | 5.8 | (5.6, 6.1) | 0.673 |
| Polyp | only | | | | | | | | | | |
| | Distal | 76 | 30.4 | (24.8, 36.5) | 135 | 27.0 | (23.2, 31.1) | 10,898 | 26.1 | (25.6, 26.5) | 0.963 |
| | only | | | | | | | | | | |
| | Both | 7 | 2.8 | (1.1, 5.7) | 25 | 5.0 | (3.3, 7.3) | 1,271 | 3.0 | (2.9, 3.2) | 0.277 |
| | Not | 0 | 0.0 | (0.0, 1.5) | 1 | 0.2 | (0.0, 1.1) | 537 | 1.3 | (1.2, 1.4) | 0.078 |
| | specified | | | | | | | | | | |

*Based on reference standard annotations. “C.I = confidence interval.”
**Based on NLP derived variables excluding those that were in testing and training sets.

Accuracy of colorectal cancer detection was 99.6%, advanced adenoma 95.0%, non-advanced adenoma 94.6%, advanced sessile serrated polyp 99.8%, non-advanced sessile serrated polyp 99.2%, ≧10 mm hyperplastic polyp 96.8%, and <10 mm hyperplastic polyp 96.0%. Lesion location showed high accuracy (87.0-99.8%). The number of adenomas had an accuracy of 90.2%. Table 11 shows the recall, precision, f-measure, and accuracy of the system across the 19 content measures. Analysis of the test set showed 156 (31.2%) of the 500 documents with a least one discrepancy among the nineteen content measures. Overall, 332 (3.5%) of the 9,500 annotations points were classified incorrectly by NLP. Manual post hoc review of the 156 cases revealed 129 (83.2%) due to NLP error, 23 (14.8%) due to annotator error (e.g., advanced adenoma labeled as a cancer with “tubulovillous adenoma with focal adenocarcinoma in situ”), 5 (3.2%) due to both annotator and NLP error, and 8 (5.2%) due to documents that contained no clear answer (e.g., “tubular adenoma with high grade dysplasia suspicious for adenocarcinoma”).

TABLE 11
Recall, precision, f-measure, and accuracy from test set (n = 500).

| | | Number in | | | | | |
|---|---|---|---|---|---|---|---|
| Content Measure | | set (%)* | | Recall | Precision | Accuracy | F-Measure |
| Is there cancer? | | 17 | (3.4) | 0.97 | 0.97 | 0.996 | 0.97 |
| Location of | None | 483 | (96.6) | 0.998 | 0.998 | | |
| the cancer? | Proximal | 10 | (2.0) | 0.900 | 0.750 | | |
| | Distal | 7 | (1.4) | 0.429 | 0.600 | | |
| | Proximal | 0 | (0.0) | n/a | n/a | | |
| | and distal | | | | | | |
| | Any location | | | 0.776 | 0.783 | 0.988 | 0.779 |
| Is there an advanced | | 97 | (19.4) | 0.906 | 0.930 | 0.95 | 0.918 |
| adenoma? | | | | | | | |
| Location of | None | 403 | (80.6) | 0.978 | 0.956 | | |
| advanced | Proximal | 46 | (9.2) | 0.739 | 0.895 | | |
| adenoma? | Distal | 45 | (9.0) | 0.844 | 0.776 | | |
| | Proximal | 6 | (1.2) | 0.167 | 1 | | |
| | and distal | | | | | | |
| | Any location | | | 0.907 | 0.682 | 0.934 | 0.778 |
| Is there a conventional | | 273 | (54.6) | 0.947 | 0.945 | 0.946 | 0.946 |
| adenoma? | | | | | | | |
| Location of | None | 227 | (45.4) | 0.969 | 0.891 | | |
| conventional | Proximal | 126 | (25.2) | 0.857 | 0.824 | | |
| adenoma? | Distal | 92 | (18.4) | 0.772 | 0.877 | | |
| | Proximal | 55 | (110) | 0.655 | 0.878 | | |
| | and distal | | | | | | |
| | Any location | | | 0.867 | 0.813 | 0.870 | 0.839 |
| Is there an advanced | | 1 | (0.2) | 0.999 | 0.75 | 0.998 | 0.857 |
| sessile serrated polyp? | | | | | | | |
| Location of | None | 499 | (98.8) | 0.998 | 1 | | |
| advanced | Proximal | 0 | (0.0) | n/a | n/a | | |
| sessile | Distal | 1 | (0.2) | 1 | 0.5 | | |
| serrated | Proximal | 0 | (0.0) | n/a | n/a | | |
| polyp? | and distal | | | | | | |
| | Any location | | | 0.999 | 0.750 | 0.998 | 0.857 |
| Is there a non-advanced | | 11 | (2.2) | 0.863 | 0.941 | 0.992 | 0.900 |
| sessile serrated polyp? | | | | | | | |
| Location of | None | 489 | (97.8) | 0.998 | 0.994 | | |
| non-advanced | Proximal | 4 | (0.8) | 0.500 | 0.500 | | |
| sessile | Distal | 1 | (0.2) | 0.714 | 1 | | |
| serrated | Proximal | 0 | (0.0) | n/a | n/a | | |
| polyp? | and distal | | | | | | |
| | Any location | | | 0.737 | 0.831 | 0.990 | 0.782 |
| Is there a ≧10 mm | | 8 | (1.6) | 0.553 | 0.543 | 0.968 | 0.548 |
| hyperplastic polyp? | | | | | | | |
| Location of ≧10 mm | None | 492 | (98.4) | 0.982 | 0.988 | | |
| hyperplastic | Proximal | 2 | (0.4) | 0 | 0 | | |
| polyp? | Distal | 5 | (1.0) | 0.200 | 0.125 | | |
| | Proximal | 1 | (0.2) | 0 | 0 | | |
| | and distal | | | | | | |
| | Any location | | | 0.295 | 0.370 | 0.968 | 0.329 |
| Is there a <10 mm | | 193 | (38.6) | 0.953 | 0.963 | 0.96 | 0.958 |
| hyperplastic polyp? | | | | | | | |
| Location of <10 mm | None | 308 | (61.6) | 0.984 | 0.938 | | |
| hyperplastic | Proximal | 32 | (6.4) | 0.719 | 0.767 | | |
| polyp? | Distal | 135 | (27.0) | 0.881 | 0.915 | | |
| | Proximal | 25 | (5.0) | 0.600 | 0.882 | | |
| | and distal | | | | | | |
| | Average | | | 0.876 | 0.796 | 0.920 | 0.834 |
| Total number | 0 | 183 | (36.7) | 1 | 0.973 | | |
| of adenomas | 1-2 | 231 | (46.2) | 0.887 | 0.903 | | |
| removed? | 3-9 | 86 | (17.2) | 0.733 | 0.759 | | |
| | ≧10 | 0 | (0.0) | 0 | 0 | | |
| | Any location | | | 0.873 | 0.659 | 0.902 | 0.751 |
| At least 5 sessile serrated | | 0 | (0.0) | 1 | 1 | 1 | 1 |
| polyps proximal to the | | | | | | | |
| sigmoid with 2 or more ≧10 | | | | | | | |
| mm? | | | | | | | |
| ≧20 sessile serrated | | 0 | (0.0) | 1 | 1 | 1 | 1 |
| polyps throughout the | | | | | | | |
| colon? | | | | | | | |
| Total number of | 0 | 306 | (61.2) | 0.987 | 0.974 | | |
| hyperplastic | 1-9 | 194 | (38.8) | 0.959 | 0.979 | | |
| polyps | 10-19 | 0 | (0.0) | n/a | n/a | | |
| removed? | ≧20 | 0 | (0.0) | n/a | n/a | | |

| | | | | |
|---|---|---|---|---|
| Average | 0.977 | 0.973 | 0.976 | 0.975 |

| | | | | | | |
|---|---|---|---|---|---|---|
| Was a mass identified? | 13 | (2.6) | 0.604 | 0.597 | 0.958 | 0.600 |

*Number in set based on gold standard paired annotation.

Regarding Table 11 above, recall is a statistical measure similar to sensitivity, and was defined as:

reports in agreement+positive reports according to the reference standard.

Precision is a statistical measure for NLP similar to positive predictive value (“PPV”), and was defined as: reports in agreement+positive reports by NLP. Accuracy was defined as:

(true positives+true negatives)+(true positives+false positives+true negatives+false negatives)

The f-measure was defined as: 2 (precision×recall)+(precision+recall) and is used to quantify the effectiveness of information retrieval. Values for recall, precision, accuracy, and f-measure vary between 0-1, with 1 being optimal.

The error rate within the 500 test documents across any of the 19 measures was 312% for the NLP system and 25.4% for the paired annotators (p=0.001). At the content point level, the error rate was 3.5% in the NLP system and 1.9% for the paired annotators (p=0.04). In the post-hoc analysis, removal of the 8 vague documents and correction of the NLP and annotator errors based on the adjusted reference standard with a priori definitions resulted in 125 of 492 (25.4%) incorrect assignments by NLP and 104 of 492 (21.1%) by the initial annotator (p=0.07).

ADR was 29.1%±5.0 (range, 19.3-38.0%) across the 13 VA institutions. Detection rates for subgroups included an advanced adenoma detection rate of 7.7%, sessile serrated polyp detection rate of 0.6%, and proximal adenoma detection rate of 11.4%.

The above-described example shows that natural language processing is a method to address the problem of extracting information from free text documents stored within the electronic medical record. Variation in how providers express concepts is quite wide, however, and requires an accurate method for context-specific assessment. The example demonstrated high accuracy across multiple measures for colonoscopy quality and surveillance interval determination from 13 diverse institutions with different report writers.

NLP has been used in other attempts to quantify meaningful information from colonoscopy reports; however, herein provided are robust accuracies which include a more detailed analysis of the individual pathologic findings (e.g., advanced adenoma, conventional adenoma, advanced sessile serrated polyp) and a variety of textual inputs for analysis. The preceding example provides a broad scope of accurate identification of meaningful information by expanding to thirteen geographically distinct VA centers. The NLP system maintained a high level of accuracy (94.6-99.8%) throughout nine pathologic sub-categories. The high level of accuracy was found for lesion location (87.0-99.8%) and for number of adenomas removed (90.2%).

This example shows, in one embodiment, the ability to translate an open source, customized, information technology into a clinically meaningful system for quality tracking and secondary data utilization. The impact of a quarterly report card utilizing ADR has previously been shown to improve this quality indicator. Reports can be further extracted for quality monitoring with the ability to detect location specific and categorized pathology (e.g., average number of adenomas per screening exam). The NLP system showed consistency across the non-annotated data (Table 10) for 32 of 35 comparisons. The variance is likely explained by the low prevalence of some findings (e.g., distal sessile serrated polyp), no specific location specified (e.g., non-specified location in non-advanced adenomas), and multiple testing.

RUM Thus, in some embodiments, a broad range of sources could be used to generate a patient- and context-specific recommendation for a colonoscopy surveillance interval. With the underlying open source software (cTakes), there is a limited cost and time commitment for mobilization and implementation of this system within a production electronic health record. This system could be utilized widely, including with providing and referring clinicians, credentialing committees, and payers for appropriate utilization.

A robust reference standard was used in the preceding study. Work was performed in paired, blinded, adjudicated fashion on 750 documents with 14,250 data points. During this process, it was identified that a board-certified gastroenterologist had a report discrepancy rate of 25.4% for annotation across the 19 metrics. After adjustment for documents without a clear answer and those incorrectly labeled as a reference standard, review of documents for quality measurement by an expert would have comparable accuracy (p=0.07) and be more costly than an automated system. As well, there is room for improvement within the NLP system. In analyzing the test set, it was found that some errors occurred due to the lack of synonym identification (e.g., “adenoma with focal superficial atypia” should be classified as an advanced adenoma), which is easily corrected. In some embodiments of the present invention, multiple synonyms could be added to a custom dictionary for identification within electronic health records.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 is a flow chart for colonoscopy quality metric extraction.

FIG. 2 is a flow chart for ERCP quality metric extraction.

FIGS. 3 and 4 are flowcharts which outline the overall TRAQME framework.

FIGS. 5-8 are flowcharts which outline the decision logic in one embodiment of the TRAQME framework clinical decision support software.

FIG. 9 is an example of a free text colonoscopy report.

FIG. 10 is an example of sentence breaking within a free text colonoscopy report.

FIG. 11 is an example of word identification within a free text colonoscopy report.

FIG. 12 is an example of word negation within a free text colonoscopy report.

FIG. 13 is an example of named entity recognition within a free text colonoscopy report.

FIGS. 14 and 15 are examples of concept linking within a free text colonoscopy report.

FIG. 16 is a flow chart for TRAQME clinical decision support.

FIG. 17 is a flow chart showing one embodiment of TRAQME clinical decision support software logic.

FIG. 18 is a flow chart showing how a study sample was determined in a study of colonoscopy records at 13 VA centers.

FIG. 19 is a conceptual diagram showing an exemplary embodiment of a TRAQME system.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF THE DRAWINGS

The embodiments disclosed herein are not intended to be exhaustive or limit the disclosure to the precise form disclosed in the following detailed description. Rather, the embodiments are chosen and described so that others skilled in the art may utilize their teachings.

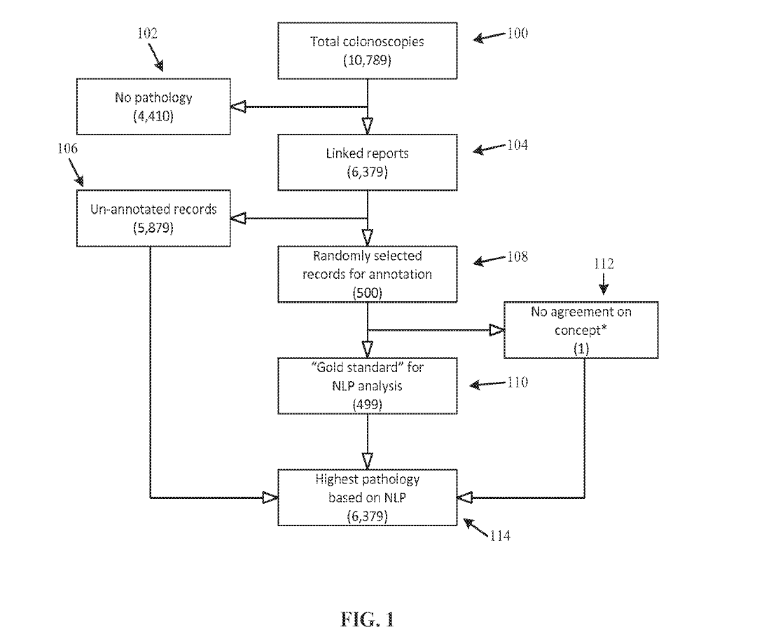

Referring first to FIG. 1, a flow chart of a process for a data extraction study is shown. In one such study, compared to manual review, NLP had an accuracy of 98% for the most advanced lesion, 97% for location of most advanced lesion, 96% for largest adenoma removed, and 84% for number of adenomas removed. In the first stage 100 of the study, total colonoscopy records numbered 10,789. These were divided between those with no pathology (which were not analyzed, shown at stage 102 and numbering 4,410) and those with pathologies, shown at stage 104 as linked reports numbering 6,379. At stage 108, 500 records were randomly selected for records annotation, and 5,879 un-annotated records were separately analyzed at stage 106. At stage 110, it was determined that 499 met the “Gold Standard” (agreement on annotation by more than 1 expert) for NLP analysis, and at stage 112 it was determined there was no agreement on the concept in 1 case. At stage 114, the highest pathology based on NLP for the 6,379 records was determined.

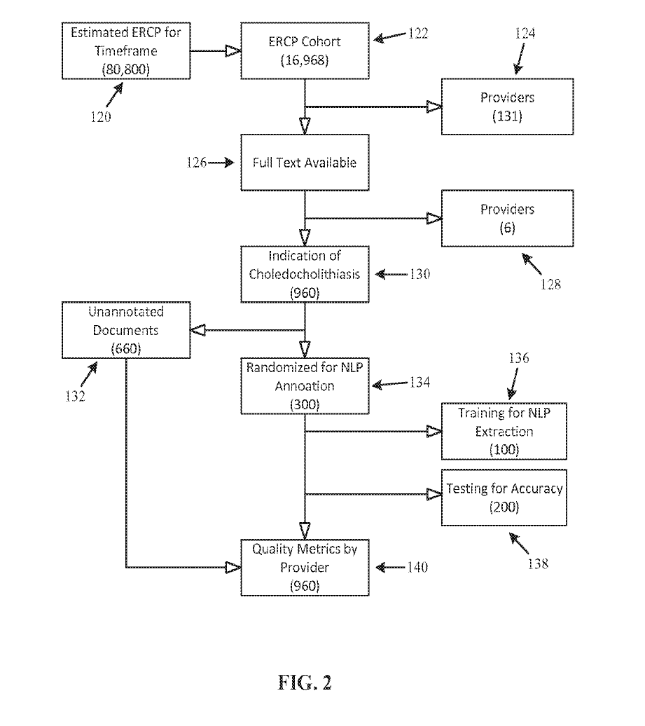

Referring now to FIG. 2, a flow chart of a process for ERCP quality metric extraction is shown. In one embodiment, the estimated number of ERCP's for a timeframe was 80,800 shown in stage 120. The ERCP Cohort, shown at stage 122, was 16,968 ERCP's. At stage 124, there were 131 available providers. After the ERCP Cohort, the Full Text was made Available at stage 126, and at stage 128 the number of providers was 6. At stage 130, it was shown there was indication of choledocholithiasis in 960 documents. At stage 132 660 unannotated documents were separated. 300 documents were randomized for NLP annotation at stage 134. One hundred documents were used for training for NLP extraction in stage 136, and testing for accuracy was performed on 200 documents in stage 138. The quality metrics by provider were then shown for the 960 documents in stage 140.

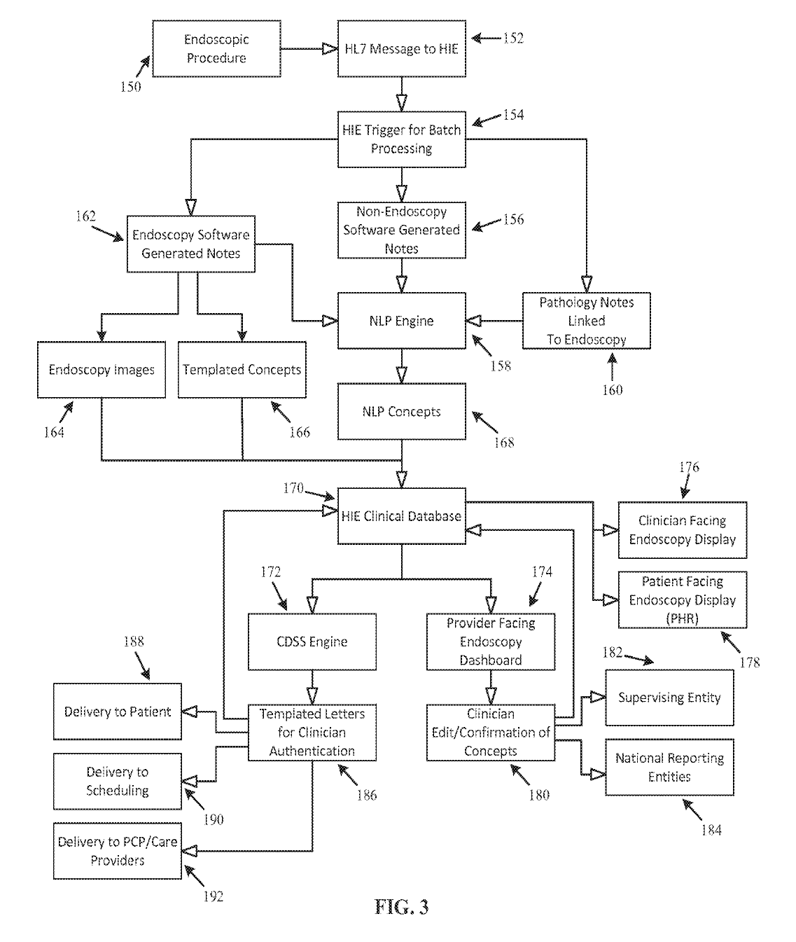

Referring now to FIG. 3, a flowchart which outlines the TRAQME framework is shown. Such an embodiment may optionally include: (1) a clinical decision support system for processing surveillance recommendations; (2) a quality dashboard for endoscopic procedures for providers; (3) letter generation from CDS Software surveillance recommendations to be delivered through Docs4Docs; (4) Reporting to GIQuIC and other national reporting systems of adenoma detection rates, quality measures, and surveillance guideline adherence rates; and (5) patient facing interface for interaction with colonoscopy reports.

In FIG. 3, an endoscopic procedure is performed at stage 150. The procedure is optionally transmitted via HL7 messaging to a health information exchange (“HIE”) at stage 152. Next, a health information exchange trigger for batch processing is provided at stage 154. Non-endoscopy software generated notes created at stage 156 can be fed to a NLP engine at stage 158. Additionally, pathology notes linked to endoscopy created at stage 160 can be fed to the NLP engine at stage 158. Endoscopy software generated notes created at stage 162 can be fed to the NLP engine at stage 158 or can be broken down to endoscopy images at stage 164 and templated concepts at stage 166. The NLP engine uses NLP concepts at stage 168, and optionally the endoscopy images from stage 164 and templated concepts from stage 166, and the extracted data set goes to a HIE clinical database at stage 170.

Following the HIE clinical database at stage 170, there are optionally a clinical decision support software engine provided at stage 172, a provider facing endoscopy dashboard at stage 174, a clinician facing endoscopy display at stage 176, a patient facing endoscopy display with patient health record (“PHR”) at stage 178, a stage for clinician edits or confirmation of the concepts at stage 180, a supervising entity or entities at stage 182, national reporting entities at stage 184, templated letters for clinician authentication at stage 186, delivery to patient at stage 188, delivery to scheduling at stage 190, and delivery to primary care Providers or other care providers at stage 192.

The provider facing endoscopy dashboard, clinician facing endoscopy display, and patient facing endoscopy display provided at stages 174, 176, and 178, respectively could be any fixed or portable screen or screens, optionally with visual and/or audible output and user controls. The screens may be touchscreens for input by a patient, provider, or clinician. The screens could, in some embodiments, provide real-time data, such as, for example, a clinician's recommended surveillance interval vs. a payer's recommended surveillance interval, vs. a patient's preferred surveillance interval. The screens could be interactive and mobile, and receive and send data either through wired connections or wirelessly.

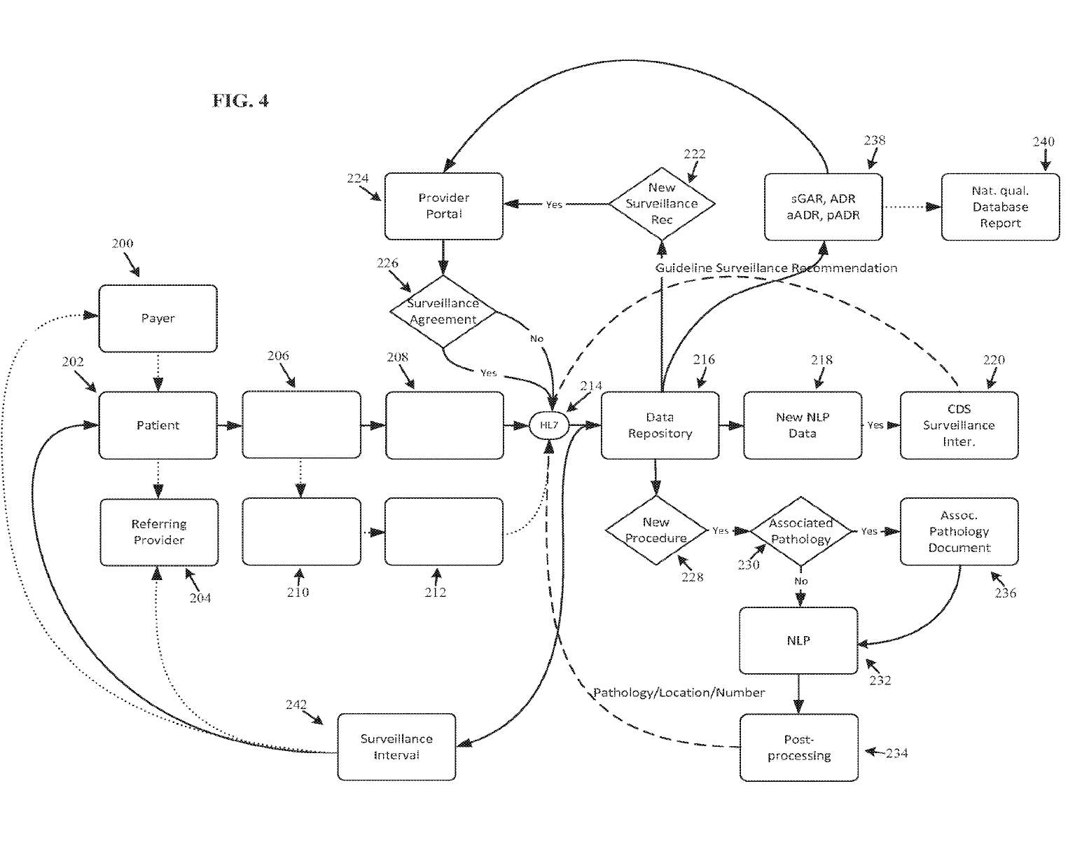

Referring now to FIG. 4, a flowchart which outlines the TRAQME framework is shown. Starting with decision stages 200, 202, 204, after a payer, patient, and referring provider confer, a patient sees a physician for a colorectal exam at stage 206, which in one embodiment is a colonoscopy. During and after the exam, the doctor or health care provider produces at least one document, optionally templated or in free text format, at stage 208. A second pathology document may also be created at stage 210, a third at stage 212, or a further pathology document may also be created during and after the exam. From these documents, NLP extracted concepts, along with data that are currently stored within templated endoscopy software (Provation® MD Gastroenterology; Wolters Kluwer, Minneapolis, Minn.), can be securely transferred to a health information exchange or Data Repository for storage via Health Level 7 (HL7) messaging at stage 214, HL7 is a framework for exchange, integration, sharing, and retrieval of electronic health information.

In one embodiment, information from the data repository at stage 216 can be processed to form New NLP Data at stage 218, and then analyzed to provide a CDS surveillance interval at stage 220. This surveillance interval would be transmitted back to the data repository via HL7, and then optionally provide new surveillance recommendations at stage 222 and proceed through a provider portal at stage 224, a surveillance agreement at stage 226, back to the data repository 216, and ultimately back to the payer, patient, and referring provider for use in decision stages 200, 202, and 204. The final recommended surveillance interval is provided at stage 242. In the surveillance agreement stage 226, the doctor's recommendation for a surveillance interval is measured against the surveillance interval recommended by the post-processing of NLP data.

In the embodiment shown, if the data in the data repository at stage 216 is from a new procedure shown at stage 228, the new procedure is analyzed, and if there is no associated pathology determined at stage 230, then then the data would undergo NLP at stage 232 and post-processing at stage 234 and be fed back to the data repository through HL7. If there is an associated pathology document at stage 236, this would undergo NLP and post-processing and be fed back to the data repository at stage 216. The accuracy of information in the data repository at stage 216 is optionally checked for accuracy with options such as sGAR, ADR, aADR, and pADR at stage 238 before being sent to a national quality database in stage 240 or the provider portal in stage 224.

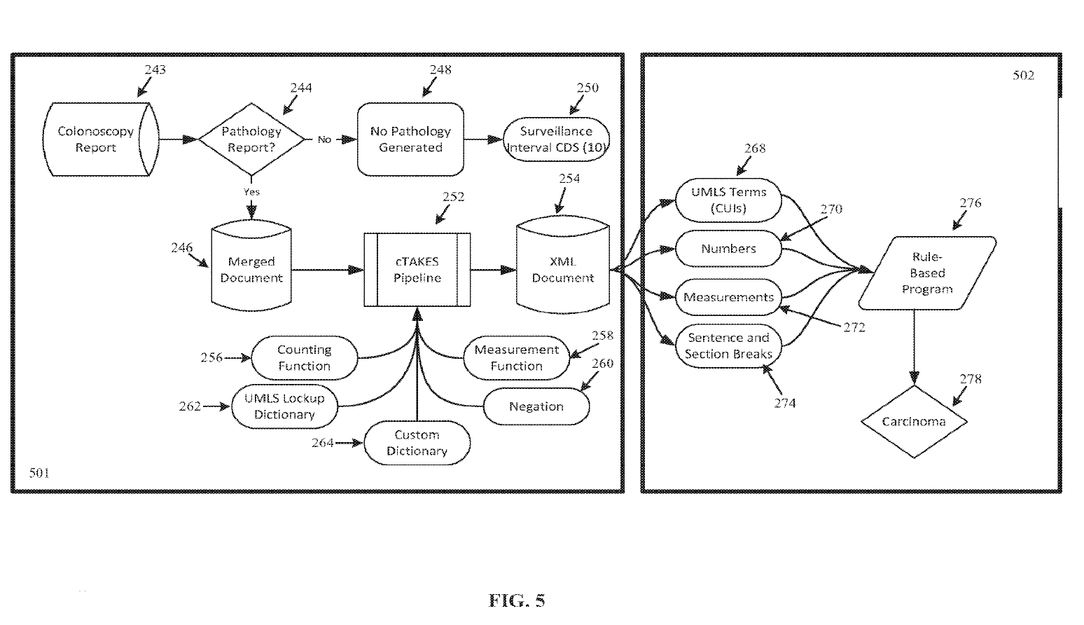

Referring now to FIG. 5, a flowchart which outlines the decision logic in the TRAQME framework is shown, and this flowchart continues into FIGS. 6, 7, and 8. Starting with FIG. 5, a colonoscopy report, or other free text report following a colorectal exam, or in other embodiments other another medical exam, is produced at step 243. In this pre-processing stage 501, colonoscopy reports produced in step 243 are analyzed for an associated pathology reports in step 244 and then merged into a single merged document at step 246 if it is determined in step 244 that there is an associated pathology report. Reports without associated pathologies are removed in step 248, and in the embodiment shown, the logic implementation system would then recommend a repeated surveillance interval for the patient of 10 years at step 250. In the embodiment shown, the logic implementation system is clinical decision support software.

Still referring to FIG. 5, if there is a pathology report associated with the colonoscopy or other colorectal exam report, the merged document in step 246 is delivered for analysis in the cTakes Pipeline shown in step 252. Each merged document is run through the cTakes Pipeline outputting a single XML document at step 254 for each merged document. The cTakes Pipeline optionally includes a counting function at step 256, a measurement function at step 258, a negation function at step 260, a unified medical language system (“UMLS”) lookup dictionary at step 262, and a custom or supplemental dictionary provided by a user or programmer at step 264.

The cTakes pipeline utilizes the built in UMLS lookup dictionary to identify terms in standardized format or concept unique identifiers (“CUIs”). A small custom dictionary is optionally added to identify terms that are not recognized by the built-in UMLS lookup dictionary. Negation of terms is identified as well as the sentence and section of each term. Numbers of identified items (such as polyps) and measurements (such as size of polyps) are identified separately. In the post-processing stage 502, table entries are created for UMLS Terms identified (“CUI's”) in step 268, numbers in step 270, measurements in step 272, and sentence and section breaks in step 274 for input into a rule-based program at step 276, which in a first step checks for a carcinoma at step 278.

Still referring to FIG. 5, after the production of XML documents at step 254, post-processing is performed on the data. The XML documents created from the merged documents input into the cTakes pipeline are imported into a local database. Numbers written as words (e.g., “two”) are converted into integers (e.g., “2”). Table entries are created for identifiable items from the merged free text report optionally including UMLS terms identified in step 268, numbers in step 270, measurements in step 272, sentence location relative to section break in step 274, and polyp numbers and size. Examples of a free text report and the tables derived from the free text report, after the free text report has undergone the cTakes Pipeline into a XML document, are shown in Tables 3-8. The data from the tables generated then enter into a rule based program, optionally implemented by software.

In one embodiment of the post-processing logic, the logic is executed by software, and for each pathology found (the pathologies with negated terms having been removed in the cTakes pipeline), if dysplasia pathology is found, the post-processing software searches earlier in the same sentence for condyloma, and if this term is identified, the finding is ignored. Thus, based on the sentences having been broken out of the XML documents by sentence, and categorized by section, medical concepts within a sentence, and within a section can be linked. Such linking is graphically shown in FIGS. 14, 15. Pathologies not ignored, such as polyps, can be written to a polyp table (or other pathology table) along with the location of the pathology. Table 7 shows an example of such a table.

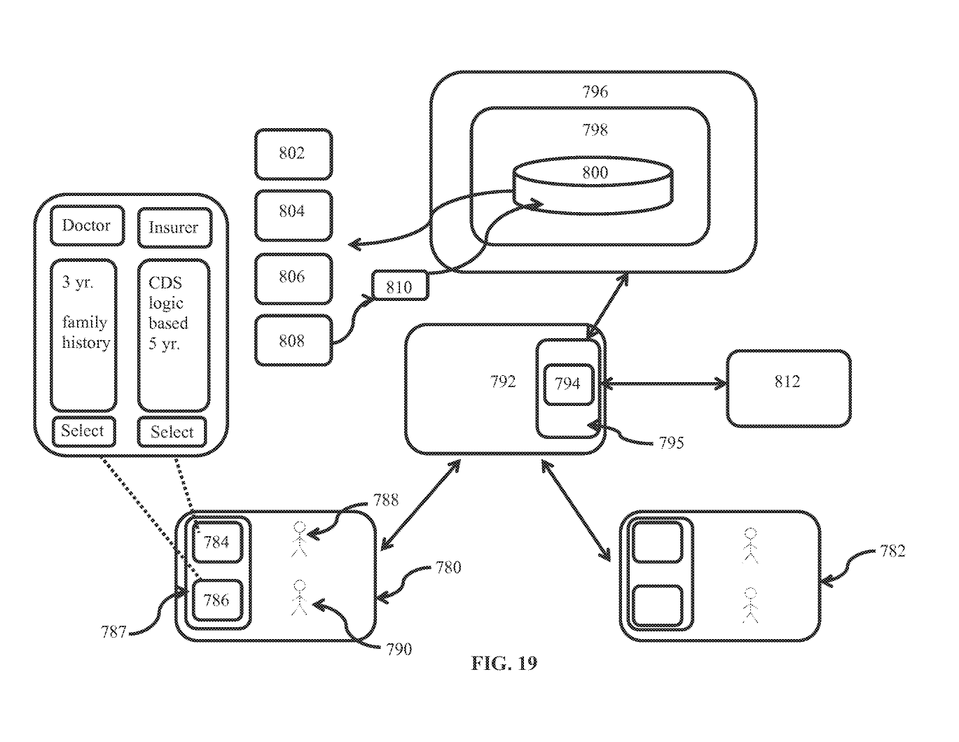

The software can be executed on a computer or series of computers connected via a network. The network might be wired or wireless, and the computer or series of computers is capable of accepting inputs from the network and sending outputs to the network. The computer or series of computers can optionally utilize processors, non-transitory computer readable storage mediums, and databases. See, for example, FIG. 19.

In another embodiment of the post-processing logic, for each measurement found in the Findings section of the free text merged document, if the units of a numeral are not in millimeters (“mm”) or centimeters (“cm”), then the units are ignored. For colonoscopy data, if the measurement is greater than about 50 mm, then the unit attached to the numeral is optionally ignored. If the measurement numeral is within the range of the logic provided and the correct unit measure is found, the logic analyzes the location to the left or right of measurement in the text, and matches the measurement to the pathology using the location within the sentence or section, and can add that to a polyp or other pathology table along with the size of the identified pathology. In one embodiment, if a measurement is greater than 10 mm and the identified pathology is an adenoma, the logic upgrades the categorization of the pathology to an advanced adenoma in the polyp table. In another embodiment, if more than one measurement is found for the same location (pathology), only the largest size pathology is saved to the table.

In another embodiment of the post-processing logic, for each number that is not identified as a measurement in the Findings section, the location to the right of the number in the free text document (for example if the number is between line units 30 and 32 from the text, then the logic looks to units >32) to match the number to the pathology using the location, and that number is added to the pathology table, in one embodiment a polyp table, as the quantity of the identified pathology. If more than one quantity is found for the same location, in one embodiment, only the largest quantity of pathology is saved to the table.

In the post-processing stage, a key table is optionally written. In one embodiment, if non-negated hemorrhoids are identified in the document, these are noted in the key tale, along with non-negated diverticulosis. From a pathology table, optionally a polyp table, the highest level of pathology is identified, in one embodiment the worst lesion. If the location of the lesion was identified (such as proximally, distally, or both) then this location is also noted in the key table. The logic scans pathologies, such as adenomas, for the largest size based on unit measure, and this is input into the key table. The number of polyps identified as adenomas is added together, and this is reported in the key table as the number of adenomas.

Now referring to FIG. 6, logic rules, in one embodiment implemented by software, are executed on the data in the tables from the post-processing stage, and optionally on a key table which as described above summarizes important data from the other tables.

In one embodiment, if a patient carcinoma is identified at step 278, the surveillance interval provided by clinical decision support (“CDS”) at step 280 is a warning to be discussed with the patient. If there is a tubulovillous adenoma identified at step 282, the surveillance interval provided by CDS is 3 years at step 284. If there is a tubular adenoma identified at step 286, the size at step 288 is analyzed, and if it is greater than or equal to 10 mm, the surveillance interval provided by CDS is 3 years at step 284. If the tubular adenoma is less than 10 mm, and there is dysplasia determined at step 290, the surveillance interval provided by CDS is 3 years at step 284. If there is no dysplasia found at step 290 and the size of the tubular adenoma is under 10 mm, the number of tubular adenomas at step 292 is reviewed, and with 1 or 2 the recommended surveillance interval is 5-10 years recommended at step 294, if there are 10 or more, the surveillance interval is less than 3 years recommended at step 296, and if there are 3-9 the surveillance interval is 3 years recommended at step 284.

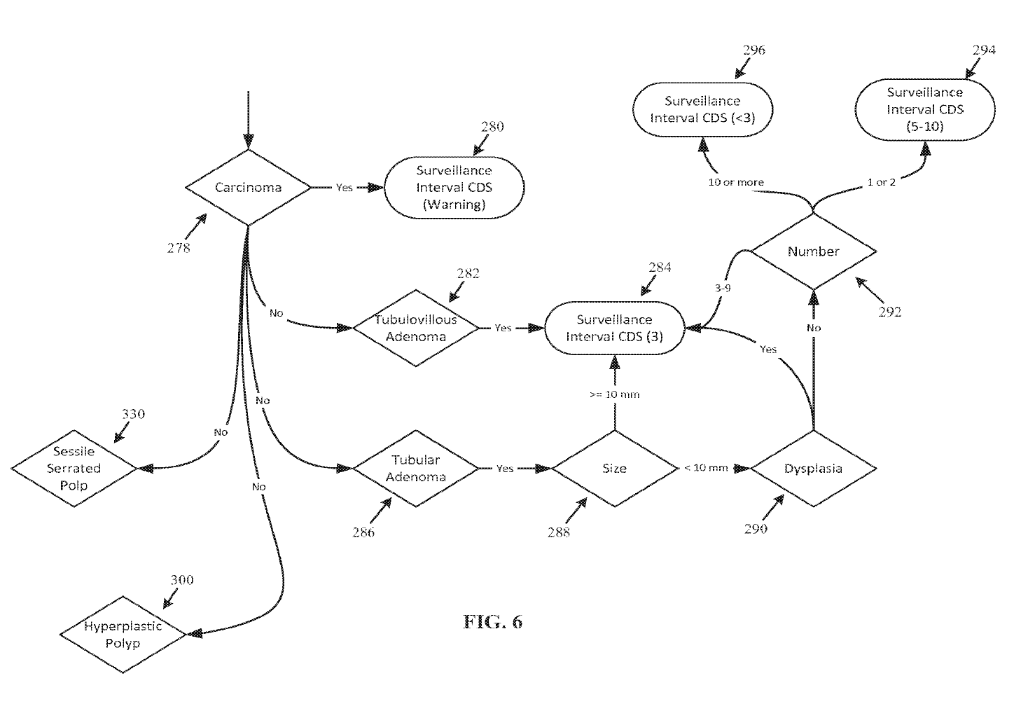

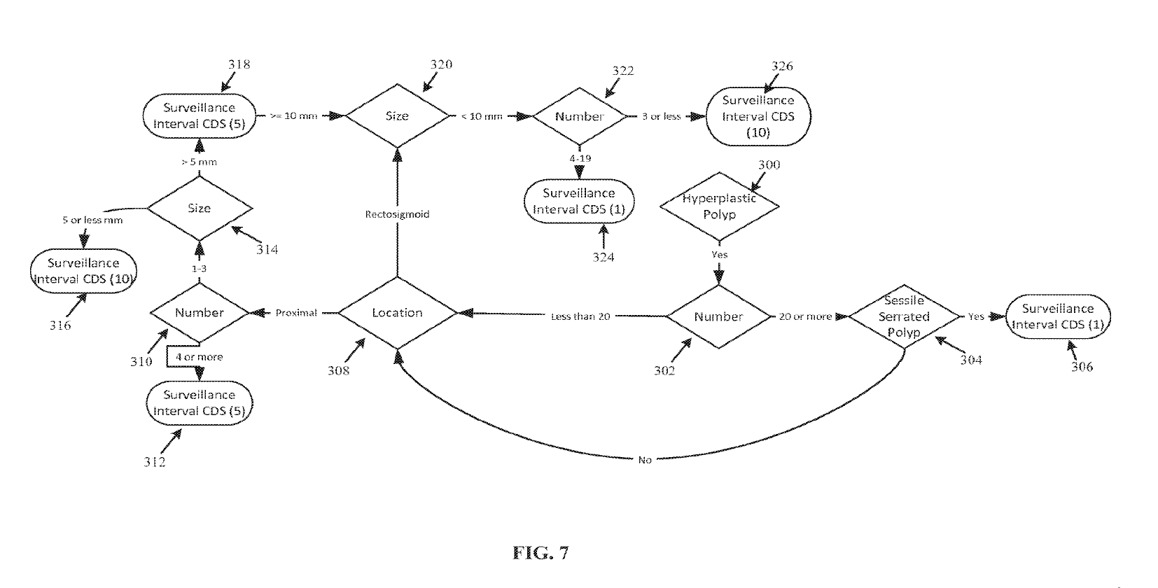

Referring now to FIG. 7, if there is no carcinoma, but there is at least one hyperplastic polyp identified at step 300, the number is analyzed at step 302. If there are 20 or more and there is a sessile serrated polyp identified at step 304, then the surveillance interval provided by CDS is 1 year at step 306. If there are 20 or more hyperplastic polyps identified and no sessile serrated polyps, or less than 20 hyperplastic polyps identified, then the location is analyzed at step 308. If the location is proximal, and the number identified at step 310 is 4 or more, the surveillance interval provided by CDS is 5 years at step 312. if there are between 1 and 3 proximal, then the size is analyzed at step 314, and if all are 5 or less mm, the surveillance interval provided by CDS is 10 years at step 316, and if one or more is greater than 5 mm the surveillance interval recommended by CDS is 5 years at step 318.

If the location of the less than 20 hyperplastic polyps or more than 20 hyperplastic polyps without a sessile serrated polyp is rectosigmoid, then the size is analyzed at step 320. If any are greater than or equal to 10 mm in size, the surveillance intervals provided by clinical decision support is 5 years at step 318. If the polyps are less than 10 mm, the number is analyzed at step 322, and if there are between 4 and 19 the surveillance interval provided by CDS is 1 year at step 324, and if there are 3 or less, the surveillance interval provided by CDS is 10 years at step 326.

Referring now to FIG. 8, if there is no carcinoma, but there is a sessile serrated polyp identified at step 330 and serrated polyposis syndrome is identified at step 332, then the recommended surveillance interval provided by CDS is 1 year at step 334. If there is no serrated polyposis syndrome and only traditional serrated adenoma is identified at step 336, then the surveillance interval recommended is 3 years at step 338. If it is not a traditional serrated adenoma and there is dysplasia identified at step 340, then the recommended surveillance interval provided by CDS is between 1 and 3 years at step 342.

If there is no dysplasia, the size of the sessile serrated polyp(s) is analyzed at step 344, and if the size is greater than or equal to 10 mm, then the number is identified at step 346 and analyzed in such a way that 2 or more will lead to a surveillance interval CDS guideline of 1-3 years at step 342, and if the number is 1 the surveillance interval will be 3 years provided at step 348. However, if the size is less than 10 mm, the number at step 350 will be analyzed in such a way that 3 or more would lead to a surveillance interval provided by CDS of 3 years at step 338. One or two would lead to a surveillance interval provided by CDS of 5 years at step 352.

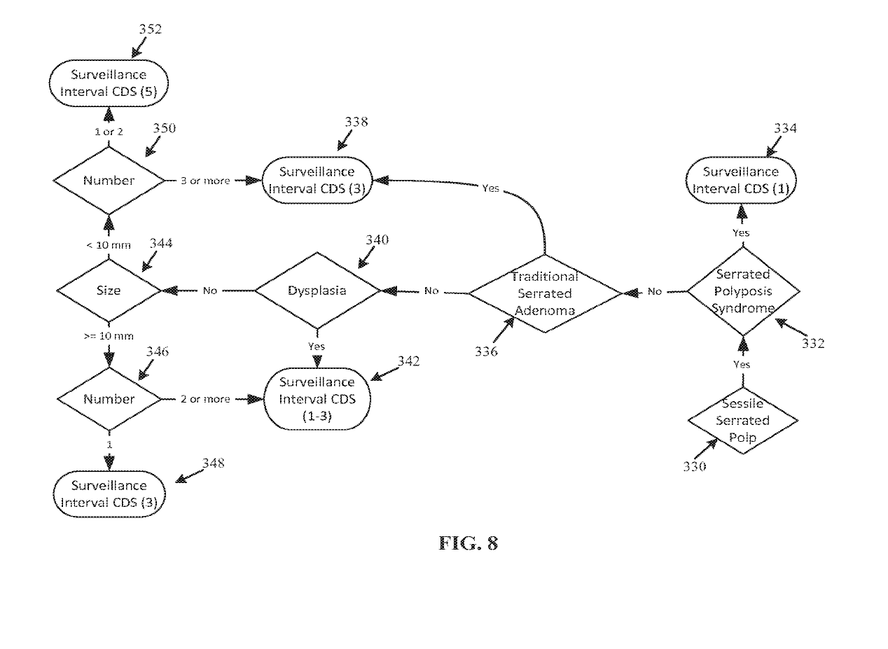

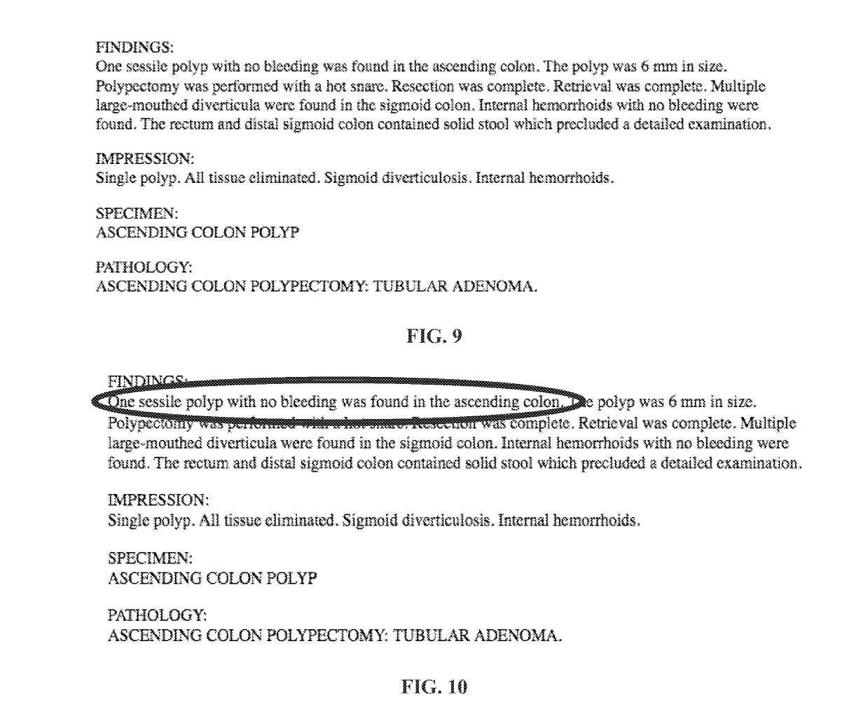

Referring now to FIG. 9, an example of a free text colonoscopy report is shown. The embodiment shown has an associated pathology, and thus could be considered a merged document of step 246 as shown in FIG. 5.

Referring now to FIG. 10, an example of sentence breaking within a free text colonoscopy report is shown. Sentences are broken out into tables and associated with section headings in post-processing.

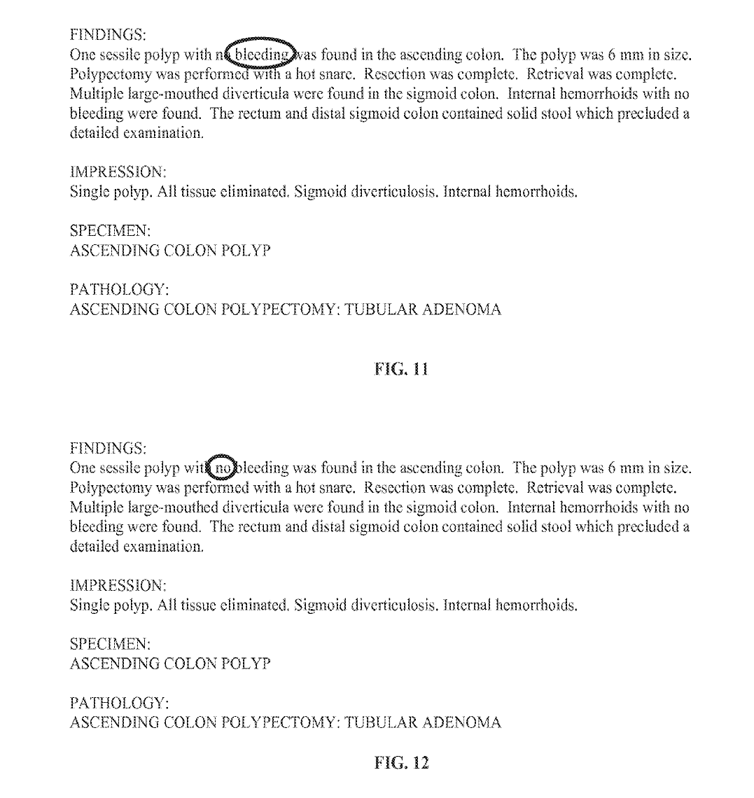

Referring now to FIG. 11, an example of word identification within a free text colonoscopy report is shown. When a word or phrase is identified, it can be matched to a UMLS lookup dictionary, or a custom or supplemental dictionary.

Referring now to FIG. 12, an example of word negation identification within a free text colonoscopy report is shown. Word negation allows cTakes to remove a pathology so that it will not appear in the tables derived from a XML document.

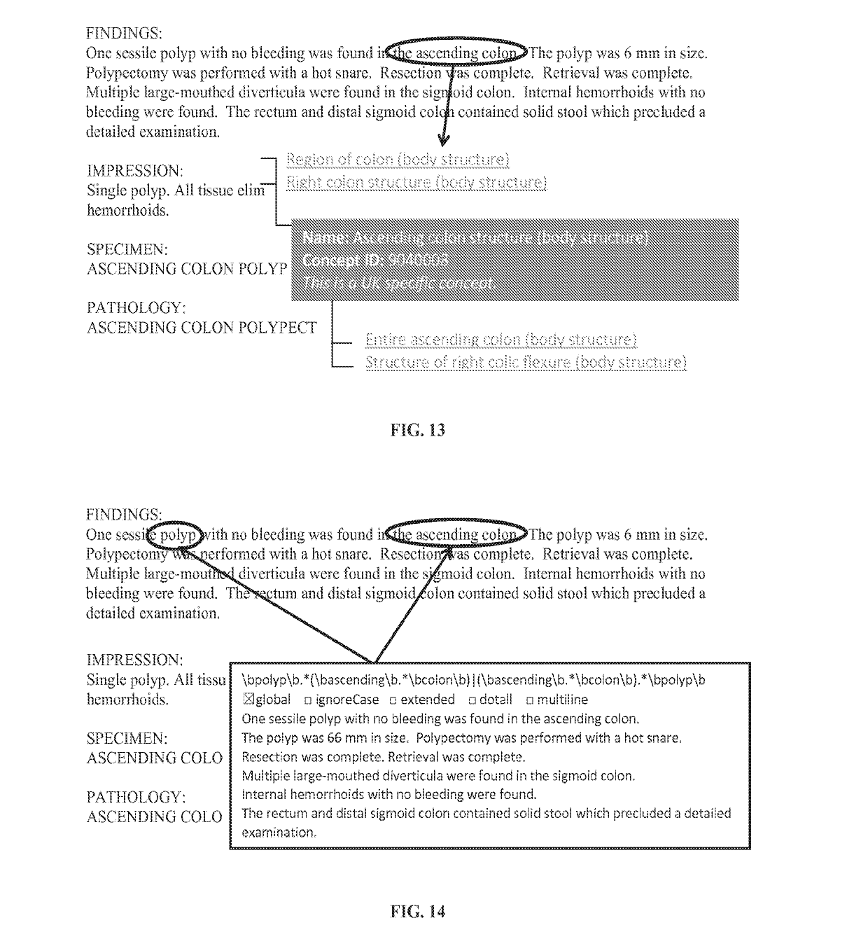

Referring now to FIG. 13, an example of named entity recognition within a free text colonoscopy report is shown.

Referring now to FIG. 14, an example of concept linking within a free text colonoscopy report is shown.

Referring now to FIG. 15, an example of complex concept linking within a free text colonoscopy report is shown. The meaningful information generated by the TRAQME system is that: (1) there is a polyp; (2) the polyp is in the ascending colon; (3) the polyp is 6 mm in size; (4) there is pathology from the ascending colon; and (5) the pathology shows tubular adenoma. Thus, TRAQME derives and concludes there is one 6 mm tubular adenoma in the ascending colon.

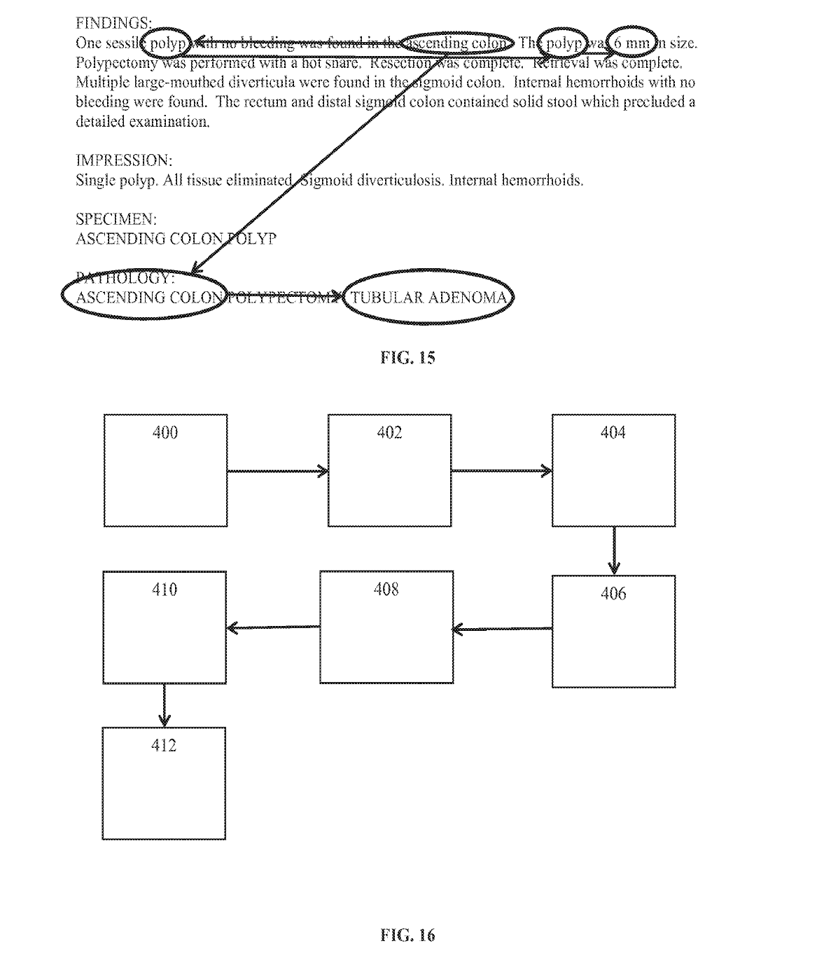

Referring now to FIG. 16, a flow chart for TRAQME clinical decision support is shown. A health care provider performs a colorectal or other health exam on a patient at step 400. Then, a free text document is produced by the health care provider optionally with findings, impression, specimen, and pathology at step 402. Next, natural language processing is executed on the free text document at step 404. Then, cTakes and modified software execute complex concept linking at step 406. Additionally, clinical decision support guidelines are applied to data from complex concept linking at step 408. Then, clinical decision support guidelines guide the health care provider in deciding the next step for the patient at step 410. Finally, the health care provider communicates to the patient next step in care at step 412.

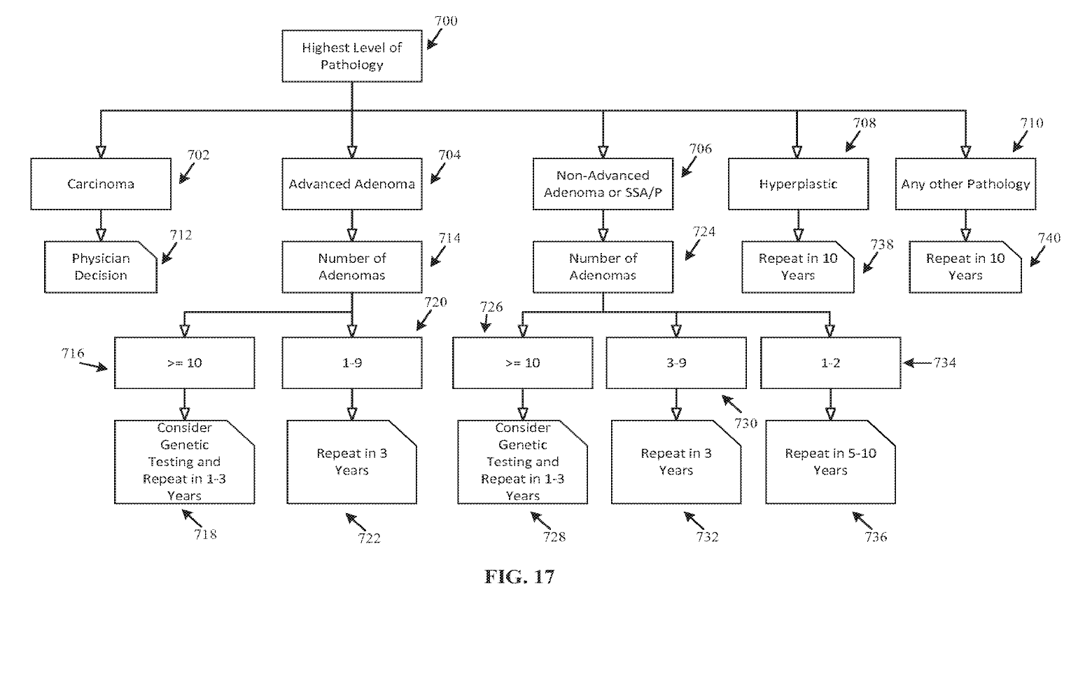

Now referring to FIG. 17, a flow chart to show one embodiment of TRAQME clinical decision support software logic is shown. The highest level of pathology is determined at step 700 by analyzing whether there is a carcinoma at step 702, advanced adenoma at step 704, non-advanced adenoma or sessile serrated adenoma or polyp at step 706, hyperplastic polyps at step 708, or any other pathology at step 710. In the embodiment shown, if a carcinoma is detected, the physician would make the clinical decision and warn the patient at step 712. If an advanced adenoma is detected at step 704, the number of adenomas is analyzed at step 714 and if there are greater than or equal to 10 at step 716, the software recommendation would be to consider genetic testing and repeat the procedure in 1-3 years at step 718. If the number of advanced adenomas in the embodiment shown is determined to be between 1-9 at step 720, then the procedure would be recommended to be repeated in 3 years at step 722.

If a non-advanced adenoma or sessile serrated adenoma or polyp was found at step 706, the number of non-advanced adenomas or sessile serrated adenomas or polyps is analyzed at step 724. If there are greater than or equal to 10 found at step 726, then the software logic recommendation would be to consider genetic testing and repeat in 1-3 years at step 728. If there were between 3-9 adenomas or polyps determined at step 730, then the software logic recommendation would be to repeat the procedure in 3 years at step 732. If there were 1-2 adenomas or polyps detected at step 734, then the software logic would return guidance to repeat the procedure in 5-10 years at step 736.

If a hyperplastic polyp at step 708 is found in the embodiment shown, the recommendation would be to repeat the procedure in 10 years at step 738. If any other pathology at step 710 were to be found, the recommendation in the embodiment shown would be to repeat the procedure in 10 years at step 740.

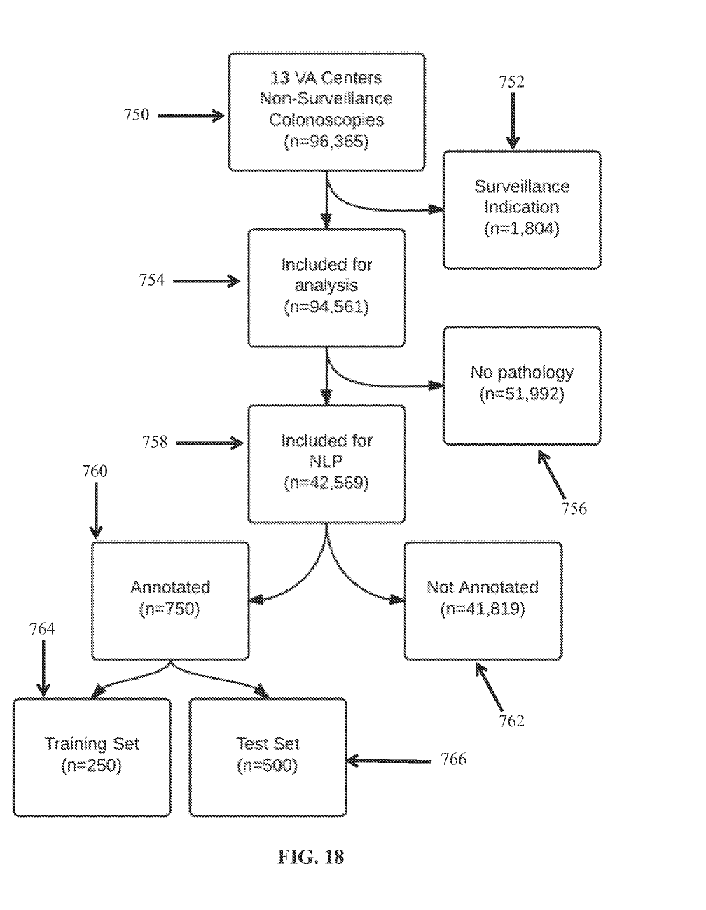

Referring now to FIG. 18, a flow chart showing how a study sample was determined in a study of colonoscopy records at 13 VA centers is shown. Of 96,365 unique subject reports gathered at step 750, 1,804 (1.9%) were excluded at step 752 by secondary text search due to surveillance indications being detected. All potentially eligible colonoscopies underwent pre-processing of the colonoscopy report using a text search of the indication field of the report with the terms “surveillance”, “history of adenoma”, “history of polyp”, and were excluded if these terms were present. Associated ICD9 codes were then searched within the documents for V12.72 (personal history of colonic polyps), 211.3 (benign neoplasm of colon), 211.4 (benign neoplasm of rectum and anal canal), and 153.* (malignant neoplasm of colon). Documents with any of these terms were excluded at step 752.

At step 754, 94,561 reports were found to meet study inclusion criteria and were used as the denominator for ADR. Of these, 51,992 (55.0%) had no associated pathology (e.g., no biopsy done during procedure) and were separated at step 756, leaving 42,569 to be processed by NLP at step 758. The 13 VA sites averaged 3,274.54±1961.1 (range, 1,012-6,995) colonoscopies per site.

Documents were stored within MySQL version 5.5.36 software, an open-source database released under the General Public License (GNU), version 2.0. Using the MySQL (RAND( )) function, 750 combined or merged reports were selected at step 760 from the 42,569 determined to be eligible for annotation at step 758 (those reports containing a pathology portion) to create a reference standard for training and testing, The 750 annotated documents were randomly split in a 2-to-1 ratio, allocating 250 documents to the training set at step 764 (documents to be reviewed by the investigators for NLP refinement) and 500 documents at step 766 to the test set. The NLP system was also run over the unselected/not annotated records (thus NLP run over n=42,569) to assess consistency with non-annotated reports.

The results of the study sample of FIG. 18 are shown in Tables 10 and 11. Accuracy of colorectal cancer detection was 99.6%, advanced adenoma 95.0%, non-advanced adenoma 94.6%, advanced sessile serrated polyp 99.8%, non-advanced sessile serrated polyp 99.2%, ≧10 mm hyperplastic polyp 96.8%, and <10 mm hyperplastic polyp 96.0%. Lesion location showed high accuracy (87.0-99.8%). The number of adenomas had an accuracy of 90.2%. Table 11 shows the recall, precision, f-measure, and accuracy of the system across the 19 content measures. Analysis of the test set showed 156 (31.2%) of the 500 documents with a least one discrepancy among the nineteen content measures. Overall, 332 (3.5%) of the 9,500 annotations points were classified incorrectly by NLP. Manual post hoc review of the 156 cases revealed 129 (83.2%) due to NLP error, 23 (14.8%) due to annotator error (e.g., advanced adenoma labeled as a cancer with “tubulovillous adenoma with focal adenocarcinoma in situ”), 5 (3.2%) due to both annotator and NLP error, and 8 (5.2%) due to documents that contained no clear answer (e.g., “tubular adenoma with high grade dysplasia suspicious for adenocarcinoma”).

Referring now to FIG. 19, an exemplary embodiment of a TRAQME system is shown. Individual care providers 780, 782 are shown. Individual care providers can be individual doctor offices, hospitals, treatment centers, treatment planning centers, immediate care centers, and/or any other medical treatment center known in the art for providing care, treatment, and/or health planning to a patient. Individual care providers 780, 782 could be individual care providers within one facility, such as individual doctors within one office or hospital, or individual care providers 780, 782 could be separate, independent, and/or unaffiliated care providers separated by any geographical distance in different buildings.

Within individual care provider 780, treatment specialist 788 is shown with patient 790. In some embodiments, treatment specialist 788 is a doctor, and in some exemplary embodiments, treatment specialist 788 is a gastroenterologist or endoscopist. However, in other embodiments, treatment specialist 788 could be any other type of doctor, nurse, medical treatment planner, and/or specialist qualified and licensed to treat and/or plan treatment for patient 790. In other embodiments, more than one treatment specialist and patient are present in individual care provider 780.

Patient 790 can be any patient present in individual care provider 780 for treatment, planning, diagnoses, check-up, or any other medical procedure.

Also within individual care provider 780, provider facing dashboard 784 and patient facing dashboard 786 are shown. In some embodiments, dashboard 784 is a provider facing endoscopy dashboard. In other embodiments, dashboard 784 is configured for other treatment methods, surveillance plans, pathologies and/or diseases. Dashboard 784 could comprise a fixed or portable screen or screens, optionally with visual and/or audible output and user controls. The screen or screens may be touchscreens for input by treatment specialist 788 or by another health care provider, or clinician. Similarly, patient facing dashboard 786 could comprise a fixed or portable screen or screens, optionally with visual and/or audible output and user controls. The screen or screens may be touchscreens for input by patient 790 or by another person such as a family member.

Dashboards 784, 786 could, in some embodiments, provide real-time data, such as, for example, a clinician's recommended surveillance interval vs. a payer's recommended surveillance interval, vs. a patient's preferred surveillance interval. Dashboards 784, 786 could be interactive and mobile, and receive and send data through wired connections, wirelessly, and/or through one or more networks. In the embodiment shown, dashboards 784, 786 are provided using a first computing device 787. First computing device 787 is capable of receiving input information through one or more wired, wireless, or network connections for display on dashboards 784, 786. First computing device 787 is also capable of receiving input information from dashboards 784, 786, input in some embodiments by treatment specialist 788 or patient 790. First computing device 787 can include one or more processors, databases, and/or non-transitory computer readable storage media. Computing device 787 is also capable of outputting information through one or more wired, wireless, or network connections. For example, data input into computing device 787 by dashboards 784, 786 could be output to a third party 792.

Individual care providers 780, 782, in the embodiment shown, transfer data either by wired or wireless means to a third party 792. Such data could be transferred from a computing device such as first computing device 787. Third party 792 might be a payer, such as an insurance company or co-op, or in other embodiments third party 792 might be a government agency or program, such as an agency tracking health care statistics, or third party 792 might be a credentialing committee, and/or any other party interested in appropriate utilization of intermittent surveillance procedures, such as colonoscopies and ERCP. In the embodiment shown, third party 792 can aggregate information from the two individual care providers 780, 782; however, in other embodiments, data can be aggregated by a third party from many more individual care providers, in some embodiments, thousands of individual care providers.

In one exemplary embodiment, treatment specialist 788 would perform a medical procedure, exam, and/or diagnosis on patient 790 at individual care provider 780. The information garnered by treatment specialist 788 would be entered into provider facing dashboard 784. The information entered into dashboard 784 may be entered into templated software and/or may be entered by free-text. The data would then be transferred by wired or wireless means to third party 792 by first computing device 787.

At third party 792, third party dashboard 794 is shown. Third party dashboard 794 could comprise a fixed or portable screen or screens, optionally with visual and/or audible output and user controls. The screen or screens may be touchscreens for input by a third party, such as an insurer or other payer, or by another health care provider, or clinician. Dashboard 794 could, in some embodiments, provide real-time data, such as, for example, a clinician's recommended surveillance interval vs. a payer's recommended surveillance interval, vs. a patient's preferred surveillance interval. Dashboard 794 could be interactive and mobile, and receive and send data either through wired connections or wirelessly.

In the embodiment shown, dashboard 794 is connected to and is provided using second computing device 795. Second computing device 795 is capable of receiving input information through one or more wired, wireless, or network connections to display on dashboard 794. Second computing device 795 is also capable of receiving input information from dashboard 794, input in some embodiments by a payer, insurer, and/or other third party. Second computing device 795 can include one or more processors, databases, and/or non-transitory computer readable storage mediums, described further below. Computing device 795 is also capable of outputting information through one or more wired, wireless, or network connections. For example, data input into computing device 795 by dashboards 794 could be output to first computing device 787 at individual care provider 780.

In the exemplary embodiment shown, dashboard 794 and second computing device 795 are connected either by a wired or wireless connection, or one or more networks, to processor 796. In other embodiments, more or fewer processors, optionally connected by wired or wireless connections, are envisioned. Processor 796 includes non-transitory computer readable storage medium 798. In other embodiments, more or fewer non-transitory computer readable storage media could be used, and in other embodiments one or more cloud-based storage media could be accessed by processor 796, either in combination with medium 798, or independently of medium 798.

In the exemplary embodiment shown, computer readable storage medium 798 includes a database 800. More or fewer databases are envisioned, and such a database may be physically located within computer readable storage medium 798, but in other embodiments database 800 may be located within a cloud-based storage medium. Database 800 includes software modules 802, 804, 806, and 808. These software modules transform raw information or data received from individual care providers 780, 782, such as, for example, patient health records, and/or pathology reports, into recommended clinical surveillance intervals.

In the embodiment shown, software module 802 is a pre-processing software module configured to transform raw patient heath data and records, either from templated or free-text entry, into one or more useful electronic documents. An exemplary pre-processing software module is shown at stage 501 in FIG. 5. For example, one or more raw colonoscopy reports, either in free text or templated form, can be transformed by the pre-processing software into a useful electronic document, which in some embodiments is a XML document. Pre-processing software module 802 might comprise NLP software.

In the embodiment shown, software module 804 is a post-processing software module configured to transform data in an electronic document produced by pre-processing software module 802 into data useful for clinical decision logic software module 806. An exemplary post-processing software module is shown at stage 502 in FIG. 5. Information from pre-processing software module 802 is rearranged in post-processing module 804, in some embodiments into one or more tables, for use in clinical decision logic software module 806. FIGS. 5-8 provide one exemplary embodiment of clinical decision logic that could be used in clinical decision logic software module 806. One or more rule-based programs is applied by module 806 to the data and numbers originally transformed from one or more raw patient health records into one or more electronic documents by pre-processing software module 802, and then into useful data and/or tables by post-processing module 804.

Surveillance recommendation software module 808 combines the rule-based surveillance recommendation from module 806 and optionally modifies the recommendation based on family history, genetic information, payer inputs, health care provider inputs, and/or any other user-desired modifications. Module 808 also provides to database 800 a transformed surveillance recommendation report 810, which in some embodiments includes a doctor report and a patient report. The patient report, in some embodiments, may contain more graphics, less data, and be more user-friendly than the doctor report.

Transformed surveillance report 810 is transferrable to dashboards 784, 786, 794 by any suitable combination of wired, wireless, and/or network connections. Transformed surveillance report 810 can be displayed against any recommendations made by a doctor or other health care provider for comparison. Transformed surveillance report 810 might, in some embodiments, include multiple clinical surveillance intervals recommended by clinical decision logic software module 806 displayed or presented against multiple individual care provider recommended surveillance intervals for the same patient health records. Such a comparison may provide a deviation for an individual health care provider for recommended surveillance intervals versus the intervals recommended by clinical decision logic software module 806 for one or more patient health care records.

Software modules 802, 804, 806, 808 can be executed on a computer or a plurality of computers connected via a network or networks. The network might be wired or wireless, and the computer or computers is/are capable of accepting inputs from the network and sending outputs to the network. The computer or computers can optionally utilize processors, non-transitory computer readable storage media, cloud-based storage media, and databases.

FIG. 19 also includes data aggregator 812, which might be a government agency, outside database, company, quality tracking consortium, and/or any other party capable of aggregating data from a TRAQME system. Data aggregator 812 can receive and send data via wired, wireless, and/or network connections to interested healthcare parties including, but not limited to, patients, payers, and providers.

Viewing all of these computer functions together or separately, for example as shown in FIG. 19, before TRAQME the industry has not known them as well-understood, routine, and/or conventional activities. The unique software modules allow for transformation of a large amount of raw patient health record data (see example above using 13 VA endoscopy units and over 10,000 health records) into useful data including, but not limited to, (1) ADR, (2) ADR comparisons between care providers, including in different regions of the country or world, (3) clinical surveillance intervals, and (4) comparison of rule-based surveillance intervals to individually prescribed surveillance intervals.

The embodiments disclosed herein are not intended to be exhaustive or limit the disclosure to the precise form disclosed in the preceding detailed description. Rather, the embodiments are chosen and described so that others skilled in the art may utilize their teachings.

What is claimed is:

1. A method for making clinical recommendations, comprising:
providing at least one pathology report by a first computing device, wherein the at least one pathology report comprises raw patient health record data;
receiving the at least one pathology report by a second computing device;
transforming the raw patient health record data in the at least one pathology report by the second computing device, wherein the second computing device comprises at least one software module including natural language processing software, and a custom pathology dictionary;
generating, using the second computing device, a document based on the transformed raw patient health record data from the at least one pathology report; and
using the document to output a rule-based clinical recommendation to the first computing device.

2. The method according to claim 1, wherein transforming the raw patient health record data in the at least one pathology report further comprises applying pre-processing software analysis to a patient health record.

3. The method according to claim 1, wherein generating a document further comprises applying post-processing software analysis to a patient health record.

4. The method according to claim 1, wherein using the document further comprises supplying a feedback loop, wherein said feedback loop provides a rule-based clinical surveillance interval to an interested healthcare party selected from the group consisting of: a patient; a doctor; an insurer; a referring provider; and a national quality database reporting center.

5. The method according to claim 1, wherein generating a document further comprises using Unified Medical Language System terms, pathology numbers, pathology measurements, and sentence and section breaks from a patient health record.

6. The method according to claim 1, wherein the clinical recommendation is based on a number, size, and location of gastrointestinal carcinomas, tubulovillous adenomas, tubular adenomas, dysplasia, hyperplastic polyps, sessile serrated polyps, and traditional serrated adenomas.

7. A computer implemented system for recommending a clinical surveillance interval comprising;
a first computing device connected to a second computing device, wherein the first computing device contains at least one pathology report transferrable to the second computing device, and wherein the at least one pathology report comprises raw patient health record data;
at least one pre-processing software module accessible by the second computing device for analysis of the at least one pathology report;
at least one post-processing software module accessible by the second computing device for analysis of the at least one pathology report;
at least one clinical decision support software module for application of clinical recommendation logic to transformed raw patient health record data from the at least one pathology report; and
a feedback loop, wherein the feedback loop provides at least one recommended clinical surveillance interval, based on application of the clinical decision support software module, to an interested healthcare party selected from the group consisting of: a patient; a doctor; an insurer; a referring provider; and a national quality database reporting center.

8. The system according to claim 7, wherein the pre-processing software module further comprises natural language processing of a merged document, wherein said merged document comprises a patient health record and a pathology report.

9. The system according to claim 8, wherein information in the merged document is related to gastroenterology.

10. The system according to claim 7, wherein the pre-processing software module produces an Extensible Markup Language (“XML”) document.

11. The system according to claim 7, wherein the post-processing software module creates data tables using Unified Medical Language System terms, pathology numbers, pathology measurements, and sentence and section breaks from the patient health record.

12. The system according to claim 7, wherein the clinical decision support software module provides a recommended clinical surveillance interval based on a number, size, and location of gastrointestinal carcinomas, tubulovillous adenomas, tubular adenomas, dysplasia, hyperplastic polyps, sessile serrated polyps, and traditional serrated adenomas.

13. A computer implemented system for tracking individual care provider deviation from clinical decision support software recommended surveillance intervals comprising:
a first computing device connected to a second computing device, wherein the first computing device contains at least one pathology report transferrable to the second computing device, and wherein the at least one pathology report comprises raw patient health record data;
at least one pre-processing software module accessible by the second computing device for analysis of the at least one pathology report;
at least one post-processing software module accessible by the second computing device for analysis of the at least one pathology report;
at least one clinical decision support software module for application of clinical recommendation logic to transformed raw patient health record data from the at least one pathology report;
at least one database for tracking of individual care providers' recommended surveillance intervals;
a feedback loop, wherein the feedback loop provides at least one recommended clinical surveillance interval, based on application of the clinical decision support software module, to an interested healthcare party selected from the group consisting of: a patient; a doctor; an insurer; a referring provider; and a national quality database reporting center; and
at least one comparison software module for providing a visual comparison of individual care providers' recommended surveillance intervals against the rule-based surveillance intervals over time.

14. The system according to claim 13, wherein the post-processing software module creates data tables using Unified Medical Language System terms, pathology numbers, pathology measurements, and sentence and section breaks from the patient health record.

15. The system according to claim 13, wherein the at least one recommended clinical surveillance interval, based on application of the clinical decision support software module is further based on the number, size, and location of gastrointestinal carcinomas, tubulovillous adenomas, tubular adenomas, dysplasia, hyperplastic polyps, sessile serrated polyps, and traditional serrated adenomas.

16. The system according to claim 13, wherein the surveillance intervals are intermittent periods between gastroenterology exams.

17. A method for tracking individual care provider deviation from clinical decision support software recommended surveillance intervals comprising:
providing a first computing device connected to a second computing device, wherein the first computing device contains at least one pathology report transferrable to the second computing device, and wherein the at least one pathology report comprises raw patient health record data;
accessing at least one pre-processing software module accessible by the second computing device for analysis of the at least one pathology report;
accessing at least one post-processing software module accessible by the second computing device for analysis of the at least one pathology report;
accessing at least one clinical decision support software module for application of clinical recommendation logic to transformed raw patient health record data from the at least one pathology report;
accessing at least one database for tracking of individual care providers' recommended surveillance intervals;
providing a feedback loop, wherein the feedback loop provides at least one recommended clinical surveillance interval, based on application of the clinical decision support software module, to an interested healthcare party selected from the group consisting of: a patient; a doctor; an insurer; a referring provider; and a national quality database reporting center; and
accessing at least one comparison software module for providing a visual comparison of individual care providers' recommended surveillance intervals against the rule-based surveillance intervals over time.

18. The method according to claim 17, wherein the post-processing software module creates data tables using Unified Medical Language System terms, pathology numbers, pathology measurements, and sentence and section breaks from the patient health record.

19. The method according to claim 17, wherein the at least one recommended clinical surveillance interval, based on application of the clinical decision support software module is further based on the number, size, and location of gastrointestinal carcinomas, tubulovillous adenomas, tubular adenomas, dysplasia, hyperplastic polyps, sessile serrated polyps, and traditional serrated adenomas.

20. The method according to claim 17, wherein the surveillance intervals are intermittent periods between gastroenterology exams.
